(19) United States
(12) Patent Application Publication
(10) Pub. No.: US 2004/0196428 A1
(43) Pub. Date: Oct. 7, 2004

(54) Liquid crystal display device

(75) Inventors: Akihiro Mochizuki, Louisville, CO (US); Haviland Wright, Kilauea, HI (US)

Correspondence Address: Barry E. Bretschneider, Morrison & Foerster LLP, Suite 300, 1650 Tysons Boulevard, McLean, VA, 22102, US

(73) Assignee: Nano Loa, Inc., Kanagawa (JP)

(21) Appl. No.: 10/766,986

(22) Filed: Dec. 24, 2003

Related U.S. Application Data
(60) Provisional application No. 60/440,827, filed on Jan. 16, 2003.

(51) Int. Cl. C09K 19/02

(52) U.S. Cl. 349/172

(57) ABSTRACT

A liquid crystal device comprising: at least,

a pair of substrates; and

a liquid crystal material disposed between the pair of substrates;

wherein the molecular initial alignment in the liquid crystal material has a parallel or almost parallel direction with respect to the alignment treatment direction for the liquid crystal material; and the liquid crystal material shows almost no spontaneous polarization which is perpendicular to the pair of substrates under the absence of an externally applied voltage.

### RELATED APPLICATION

This Application claims the priority of an application based on U.S. Provisional Application Serial No. 60/440,827 filed on Jan. 16, 2003.

### BACKGROUND OF THE INVENTION

1. Field of the Invention

The present invention relates to liquid crystal display devices, particularly to display devices which can suitably provide full motion video image, e.g., by employing ferroelectric or non-ferroelectric liquid crystals.

2. Related Background Art

Recent increase in the application field of liquid crystal displays (LCDs) shows many varieties such as the advanced cell phone displays, net personal digital assistance (PDA), computer monitors, and large screen direct view TVs. These emergent increases in the application field are mainly based on recent LCDs improvement in their performance and in their manufacturability.

On the other hand, new flat panel display technologies such as Organic Light Emission Displays (OLEDs) and Plasma Display Panels (PDPs) have been accelerated in their development and manufacturing so as to compete with LCDs. Moreover, the introduction of LCDs to new application field thereof requests new and higher performance of LCDs in order to meet with these new application fields. In particular, most of recent emergent application fields require full-color motion video image, which is still difficult to conventional LCD technology because of slow response nature of conventional LCDs. Under the above given circumstances, LCDs are being required to exhibit higher performance, in particular faster optical response in order to expand their application field competing with new flat panel display technologies which all have faster optical response performance than those for current LCD technologies. Concrete requirement in each particular application field to new LCD technologies will be described below.

(Technical Problems of Current LCD Technologies in Each Application Field)

(Advanced Cell Phone Application and Related Application Fields)

Due to recent infrastructure improvement in broad band system availability, some countries such as Korea, Japan and Norway already have commercial service of broad band to cell phones. This dramatic increase of transmittance capacity enables cell phones to treat full-color motion video images. Moreover in conjunction with wide spread of image capturing devices, such as Charge Coupling Devices (CCDs), Complimentary Metal Oxide Semiconductor Sensors (CMOS Sensors), the latest cell phones in the above countries are changing from “talking” device to “watching” devices very rapidly.

This “watching, function of the advanced cell phone is not limited to full motion video images, but also is applicable to internet browsering which requires the cell phone displays to exhibit a much higher resolution. For this particular demand, conventional LCDs based on Thin Film Transistor (TFT) technology (hereinafter, TFT-LCDS) has proven its performance of full motion video image capability in relatively large size panel displays such as those of over 6-inch diagonal screen size. Emergent competition with OLEDs in this particular application field, one of the advantages of general LCD technology is its high balance between brightness of screen and image retention and life time.

For all of display technologies, more or less, this relationship between the screen brightness and image retention, life time is always tradeoff. Due to the emissive nature of the phosphor in OLEDS, this tradeoff is much severer than that of LCDS. One of the advantages of the conventional TFT-LCDs is its free relationship between the screen brightness and the life time of the LCD itself. Because the conventional LCDs are all light switching devices and non-emissive devices, so that the LCDs are free from this tradeoff. The current life time of the TFT-LCDs is mostly determined by the backlight constituting the TFT-LCDs per se. Therefore, for cell phones and Net PDAs, which are adapted for outdoor use, it is preferred to use longer-life brighter displays, i.e., LCD base displays.

The current technical problem in the TFT-LCDs to meet with those advanced display application, which has been encountered in the case of full-color motion video images is its poor resolution at small display screen size as well as its slow optical response, which is a critical requirement for the “watching” cell phones and other carrying or portable devices.

In general, the minimum requisite resolution for the natural TV screen image needs to be Quarter Video Graphic Array (QVGA: 320×240 pixels). Based on conventional TFT-LCD technology using Red, Green and Blue (RGB) micro color-filter (as described in the following description and FIG. 1) on sub-pixel, the actual requisite number of pixel elements is (240×3)×320 pixels. Current commercially available displays for the advanced cell phone have, at most, Quarter Common Intermediate Format (QCIF: (176×3)×220 pixels), which is not enough to show TV images on the screen. In particular, in the longitudinal screen used for the cell phones and Net PDAs, the pixel arrangement resolution is more complicated than that for other applications using a landscape screen. FIG. 1 shows a typical example of the current RGB sub-pixel structures in the TFT-LCDs. Each micro color filter on-each sub-pixel works as one of the primary color elements at the TFT-LCD. Due to the very fine pitch pattern of these physically separated primary color elements, human eyes may recognize mixed color images. Each sub-pixel switches (oe selectively transmit) the light from the backlight, so that the light corresponding to the primary color may pass through the sub-pixel. Spatially divided primary color is required to keep the rectangular sub-pixel shape thereof so as to keep the square image based on the RGB sub-pixel combination. The following Table 1 shows both of sub-pixel and pixel pitches depending on the screen diagonal size in combination with the QVGA resolution.

TABLE 1
Sub pixel pitch depending on screen
size at QVGA resolution.

| Screen diagonal size | Sub-pixel pitch | Pixel pitch |
|---|---|---|
| (inch) | (μm) | (μm) |
| 10 | 211.7 | 635 |
| 5 | 95.4 | 286 |
| 2.5 | 52.9 | 159 |
| 1.25 | 26.4 | 79.3 |

This table clearly shows that the 10-inch diagonal screen size with the QVGA resolution provides enough design width in a TFT array substrate. However, the 2.5-inch diagonal screen with the QVGA resolution has only a 53 mm pitch, which is not enough as compared with the conventional design rule corresponding to 4 mm of TFT array. This extremely tight design width poses two major problems. One these problems is a reduction of aperture ratio, and the other is a reduction in the manufacturing yield due to the tight mask alignment registration. The aperture ratio reduction is a critical problem in the case of the cell phones and Net PDAs, which are driven by a battery. A smaller aperture ratio means a lower efficiency of the backlight throughput.

In conclusion, advanced cell phone displays and Net PDA applications, which are required to have a small screen size with higher resolution, as well as to be driven fast enough for full motion video images substantially without sacrificing the power consumption, would need a higher resolution while keeping with a sufficiently high aperture ratio, in addition to a sufficiently fast optical response for higher-quality full motion video image reproductivity.

Large Screen Direct View LCD TV Application

It is now well known that flat panel display technologies such as LCDs and PDPs are rapidly cutting into home-use large screen TV market, which are conventionally dominated by Cathode Ray Tube (CRT) technology, both in the fields of direct view displays and projection displays. In general, one of the advantages of TFT-LCDs as compared with those of PDPs for this particular application field is its higher resolution and its fine image quality. Due to this advantage, the TFT-LCD base TVs are now developing their market share at the CRT-dominated screen size (i.e., between 20-inches to 40-inches diagonal) market. On the other hand, PDPs which have some difficulties in fine-pitch pixel patterning, but have advantages in easy manufacture of larger panel size than that of TFT-LCDs. Accordingly, PDPs are mainly developed for the industrial use of over 60-inch diagonal screen-TVs.

TFT-LCDs have already established large market in the field of the computer monitor screen, both for laptop and desk top computers, such as 12-inches to 20-inches diagonal monitors. However, the image performance to be required in the computer monitor and TV is quite different. The screen brightness required for the computer monitor displays is limited to a lower value such as 200 cd/m² or less, because they are used in a close eye distance. The text-oriented display image content of the computer monitor displays allows substantial 32 to 64 gray shades color reproduction, instead of 256 gray shades for full-color motion video image reproduction. For the large screen direct view TV applications, particularly in the case of the over 20-inched diagonal TV screens, the screen brightness, contrast ratio, full-color gray shades, and viewing angle are very important to provide good enough image quality as TV images. In particular, the larger screen TVs such as over 35-inches diagonal TVs, its image quality is expected to be substantially the same as that of the cinema image quality, which is extremely important to provide deeper gray shades such as 512 gray shades or more, without showing image blur. Requisite resolutions for direct view TVs are those such as VGA (640×480 pixels) for National Television Standard Code (NTSC), higher resolution for Wide Extended Graphic Array (WXGA: 1,280×768 pixels), and full standard for high definition TV (HDTV: 1,920×1,080 pixels). In the large screen direct view TV applications, there is very distinct difference with the small high resolution display application. This difference is based on the screen image velocity issue. When two screen images are compared between 20-inches and 40-inches diagonal screens both having the WXGA resolution, the screen diagonal distance of the 20-inch screen is half of that of 40-inch screen. However, screen frame frequency as TV images is same between 20-inch screen and 40-inch screen. This provides an image velocity difference as shown in FIG. 2. The screen image velocity is simply in proportion to the diagonal size. When the total resolution is the same as that of WXGA, the pixel element size of 40-inch diagonal screen has four times larger than that of 20-inch diagonal screen. The larger pixel is more perceptible than smaller pixel size. In particular, a relatively slow optical response of conventional TFT-LCDS is much more perceptible in a larger pixel size, which constitutes larger screen size. This requires a faster optical response at each pixel element in the larger diagonal screen panel than that in the smaller diagonal screen panel so as to avoid the perceptible slow optical response, which is fatal problem in the TV image quality. In the CRT-base TV images, phosphor emission at each pixel element is extremely fast at a velocity such as several micro seconds as compared with the conventional TFT-LCDs, so that regardless the screen diagonal size, the screen image velocity depending on screen diagonal size is far beyond human-eye time resolution perceptive. However., the optical response at the conventional TFT-LCDs is typically several tens of milliseconds, and the inter-gray scale optical response time is couple of hundreds milliseconds. Because it is said that the typical human-eye time resolution is hundred milliseconds, the conventional TFT-LCDs' slow optical response time is perceptive enough for human-eyes. Therefore, the large screen direct view TVs using conventional TFT-LCD technology has a serious problem in terms of reproduction of natural TV images similar to CRT-base TV images for most human-eyes.

Another problem in the image quality in the conventional TFT-LCD TV is its image blur. This image blur does not result from the slow optical response of TFT-LCD, but results from its frame response. The CRT-base TV uses very short but very strong emission in a frame. This emission time from phosphor is such as several microseconds in a frame time of 16.7 milliseconds for 60 Hz of frame rate. This short but extremely strong emission gives some sort of impact to human-eyes, resulting in the whole frame image in human eyes. On the contrary, the conventional TFT-LCD image keeps the same brightness level in the period of whole frame. In a very rapid movement image, this holding-type brightness in a period of whole frame makes the resultant image blur. The cinema images based on film had same image blur problem. Now, the cinema images use mechanical shuttering to make blanking in order to avoid this image blur.

Other Applications Required Full-Color Video Image

As described above, most of recent applications of TFT-LCDs require full-color video images. Not only TV application, but also Digital versatile Discs (DVDs), gaming monitors, computer monitor displays are, used in combination with TV images. Although actual required image quality is highly dependent on the screen diagonal size, particularly in the case of TV images, CRT-equivalent TV image quality is absolutely required for all of full motion video image applications. In this very clear requirement, the conventional TFT-LCDs have a serious problem in their optical response time, in particular, inter-gray scale response as described hereinabove. Moreover, image blur due to constant brightness in a period of a frame makes the TFT-LCDs difficult to apply to TV images applications. Some trials have been conducted so as to reduce this fatal image blur problem in the TFT-LCDs by inserting backlight blanking as described in International Display Workshop in Kobe, “Consideration on Perceived MTF of Hold Type Display for Moving Image”; pp. 823-826, (1998), T. Kurita, et al. However, this method makes the backlight life time short, which is currently a dominant factor for determining the TFT-LCD life time. AS the TV application, shortening backlight life time due to this blanking, degrades THE TFT-LCD TV value significantly.

Technical Issue to be Solved

A technical problems to be solved by the present invention is somewhat dependent on the actual application field. For each particular application field, the following description shows a particular technical problem to be solved in each application.

Small Screen High Resolution Displays

As described hereinabove, the conventional micro color filter THE TFT-LCD has serious difficulty in its applicability for this particular application, due to the significantly low aperture ratio and low manufacturing yield based on smaller pixel pitch. The field sequential color method has been known as an effective way to keep a high aperture ratio in a small screen size with high resolution displays. A couple of papers on the field sequential color displays, such as International Workshop on Active Matrix Liquid Crystal Displays in Tokyo (1999), “Ferroelectric Liquid Crystal Display with Si Backplane”; A. Mochizuki, pp. 181-184, ibid.; “A Full-color FLC Display Based on Field Sequential color with TFTs”, T. Yoshihara, et al., pp. 185-188, describe some advantages of the field sequential color method in detail. As described in these papers, the field sequential color uses the same one pixel to represent Red, Green, and Blue colors in time sequentially. Fast optical response to realize the field sequential color is the most important in this system. In order to show a natural color image without providing color breaking, at least three times faster optical response in liquid crystal switching is required to have 3×frame rate than that of the conventional micro color filter color reproduction. The conventional Twisted Nematic (TN) liquid crystal drive mode, which is the most popular and current dominant drive mode, does not have enough optical switching response to satisfy this 3×frame rate. Thus, a new fast optical response liquid crystal drive mode is necessary to realize the field sequential color display. As long as we could have fast optical response drive mode, the field sequential color display may realize both high aperture ratio and high resolution as shown in FIG. 3, which provides bright, high resolution, and fast enough optical response for the advanced cell phone displays with lower power consumption.

The field sequential color display system has been introduced by using Nematic liquid crystal, Surface Stabilized Ferroelectric Liquid Crystal (SSFLC) in conjunction with silicon backplane, and TFT-driven ferroelectric liquid crystal showing analog gray scale. The field sequential color display using Nematic liquid crystal has an extremely thin panel gap of 2 μm as Nematic LCD. This realizes 180 Hz frame rate response of the liquid crystal This system enables both high aperture ratio and high resolution as described in “Denshi Gijyuts (Electronics Technology)”, July, 1998 in Tokyo “Liquid crystal fast response technology and its application”; M Okita, pp. 8-12 (in Japanese) However, this system could not fully use the advantage of high aperture ratio due to the nature of TN optical response profile as shown in FIG. 4(a). There is a very big difference in the backlight throughput efficiency between the conventional color filter with continuous emitting white backlight and field sequential color system. In the conventional color system, the aperture ratio of the panel directly represents the light throughput and image quality. However, in the field sequential color system, the light throughput and image quality such as contrast ratio and color purity are determined as a combination of properties between liquid crystal optical response profile and backlight emission timing. FIG. 4(a) and 4(b) show very simple differences in the light throughput between symmetrical and asymmetrical optical response profiles in the rise and fall thereof. As these figure show the difference, the light throughput of the field sequential color display is determined by both of the liquid crystal optical response profile and backlight emission timing. Due to the long tail nature of fall profile in the TN-LCD, most of backlight emission at fall edge is not used as display. On the contrary, the FIG. 4(b) case using symmetrical response profile both rise and fall edges, most of backlight emission is fully used as display. Therefore, in the field sequential color display, the high aperture ratio is not enough to keep low power consumption, or bright screen. A symmetrical response profile to maximize the use of backlight emission is necessary to keep bright screen with low power consumption.

Moreover, FIG. 4(a) and 4(b) show that the long tail fall profile has possible color contamination, if the tail reaches the next frame backlight emission. This case easily happens at a lower temperature range where TN shows a significantly slow optical response due to an increase in the viscosity of the liquid crystal. In this case, due to light leakage at “black” level, a significant reduction in the contrast ratio happens at the same time with color mixing. Thus, in order to obtain high performance field sequential color display, both fast optical response and symmetrical response profile are necessary. This properties are actually realized by the conventional SSFLCD and FLCD capable of providing analog gray scale The conventional SSFLCD has no analog gray scale capability, so that TFT array could not provide full-color video images due to the limited electron mobility of the TFTs. A silicon backplane may provide enough electron mobility to drive SSFLCD by pulse width modulation, to thereby provide full-color video images. However, due to an economical reason, the silicon backplane is difficult to be applied to the direct view large screen display, due to the difficulty in the combination thereof with a front lit lighting system capable of providing enough brightness. FLC capable of providing analog gray scale, such as Polymer Stabilized V-shaped Ferroelectric Liquid Crystal Display (PS-V-FLCD) described by Japanese Journal of Applied Physics; “Preliminary Study of Field sequential Full: color Liquid Crystal Display using Polymer Stabilized Ferroelectric Liquid Crystal Display”; Vol. 38, (1999) L534-L536; T. Takahashi, et. al., shows substantially the same electro-optical response with that of TV-LCD. Here, the “V-shaped” is designated as an analog gray scale capability which can be controlled by the strength of an applied electric field. In the applied voltage (V) and transmittance (T) relationship, the analog gray scale LCD shows “V-shaped” characteristic. Accordingly, hereinafter, the word “V-shaped” is equivalent with analog gray scale capability controlled by the applied electric field strength. Thus, it would be applicable to a small screen with high resolution display. This system, however, typically requires a photo-polymerization process by UV light. The UV exposure process has a risk of providing a decomposition of the liquid crystal itself. In order to avoid the liquid crystal decomposition in the UV exposure process, very strict control in the process is usually required.

In conclusion, an ideal small and high resolution display for advanced cell phone is analog gray scale which is capable of providing a rise/fall symmetrical fast optical response profile, as shown in Polymer Stabilized V-shaped FLCD, and easier control in its process than that for Polymer Stabilized V-shaped FLCD.

Large Screen Direct View TV Application

In the large screen direct view TV application, it has been said that an increase in screen size requires an increase in the image velocity. The increase in the image velocity needs a decrease in the liquid crystal optical response time at each pixel element. In an economical point of view, regardless of the liquid crystal technologies, it is extremely important to use a current existing large panel manufacturing line without necessity of introducing entirely new-manufacturing equipment. This also means that regardless of the liquid crystal technologies, most of current existing manufacturing process is applicable to a stable and well controlled production process. Therefore, fast response new the liquid crystal drive mode should preferably fit for a current standard micro color filter TFT array process. The conventional SSFLCD is superior in its extremely fast optical response, however, this has no capability in providing an analog gray scale response. Due to no analog gray scale capability, the conventional SSFLCD cannot be driven by the conventional micro color filter TFT array. The Polymer Stabilized V-shaped FLCD which has an analog gray scale capability may potentially fit for a current existing volume production line and process. One restriction of Polymer Stabilized V-shaped FLCD in terms of availability of current volume production line and process is a voltage to be applied through the TFT array. Mainly for an economical reason, the maximum applied voltage to each pixel is limited to 7V. When a polymer is used with FLC material at Polymer Stabilized V-shaped FLCD, saturation voltage control within 7V is not easy. Very strict material quality control and process control, in particular UV polymerization process control, are required to keep the saturation voltage of less than 7V. For the large screen panel manufacturing, this quality and process control are very difficult in terms of maintenance of uniformity in the large screen area. In order to keep a sufficiently wide process control window, lowering the saturation voltage of the liquid crystal is necessary. In this purpose, mixing photo polymerization material should be eliminated. Without increasing additional new process such as UV polymerization process, a stable manufacturing process capable of using an optimized current manufacturing line is very important to keep cost competitive performance.

### SUMMARY OF THE INVENTION

An object of the present invention is to provide a liquid crystal display device which is capable of solving the above-mentioned problem encountered in the prior art.

Another object of the present invention is to provide a liquid crystal display device capable of providing a display performance which is better than the liquid crystal display device in the prior art.

As a result of earnest study the present inventors have found that, it is extremely effective to constitute a liquid display device so as to provide a specific molecular initial alignment or orientation (i.e., a molecular initial alignment wherein the liquid crystal material has an almost parallel direction with respect to the alignment treatment direction; and the liquid crystal material shows substantially no spontaneous polarization which is perpendicular to a pair of substrates), instead of using the liquid crystal material in a conventional manner wherein the liquid crystal material exhibits an ordinary ferroelectric property.

The liquid crystal display according to the present invention is based on the above discovery. More specifically, the present invention includes the following embodiments.

[1] A liquid crystal device comprising: at least,

a pair of substrates; and

a liquid crystal material disposed between the pair of substrates;

wherein the molecular initial alignment in the liquid crystal material has a parallel or almost parallel direction with respect to the alignment treatment direction for the liquid crystal material; and the liquid crystal material shows almost no spontaneous polarization which is perpendicular to the pair of substrates under the absence of an externally applied voltage.

[2 A liquid crystal device according to [1], wherein the liquid crystal material is a the ferroelectric liquid crystal material.

[3] A liquid crystal device according to [1], wherein the liquid crystal molecular alignment treatment for the liquid crystal material is conducted by buffing.

[4] A liquid crystal device according to [3], wherein the liquid crystal molecular alignment treatment for the liquid crystal material is conducted in conjunction with a liquid crystal molecular alignment material providing a low surface pre-tilt angle.

[5] A liquid crystal device according to [4], wherein the low surface pre-tilt angle is 1.5° or less.

[6] A liquid crystal device according to [2], wherein the liquid crystal material shows a bookshelf layer structure or quasi-bookshelf structure at the ferroelectric liquid crystal phase.

[7] A liquid crystal device according to [6], wherein the helical pitch at the ferroelectric liquid crystal phase is 1.2 times or larger the panel gap distance of the liquid crystal device.

[8] A liquid crystal device comprising: at least,

a pair of substrates;

a liquid crystal material disposed between the pair of substrates; and

a pair of polarizing films disposed on the outside of the pair of substrates;

wherein one of the pair of polarizing films has a molecular initial alignment which is parallel or almost parallel with the alignment treatment direction for the liquid crystal material;

the other of the pair of polarizing films has a polarizing absorption direction which is perpendicular to the alignment treatment direction for the liquid crystal material; and

the liquid crystal device shows an extinction angle under the absence of an externally applied voltage.

[9] A liquid crystal device according to [8], wherein the liquid, crystal material is a the ferroelectric liquid crystal material.

[10]A liquid crystal device according to [8], wherein the liquid crystal molecular alignment treatment for the liquid crystal material is conducted by buffing.

[11] A liquid crystal device according to [10], wherein the liquid crystal molecular alignment treatment for the liquid crystal material is conducted in conjunction with a liquid crystal molecular alignment material providing a low surface pre-tilt angle.

[12]A liquid crystal device according to 8 11], wherein the low surface pre-tilt angle is 1.5° or less.

[13]. A liquid crystal device according to [9], wherein the liquid crystal material shows a bookshelf layer structure or quasi-bookshelf structure at the ferroelectric liquid crystal phase.

[14] A liquid crystal device according to [13], wherein the helical pitch at the ferroelectric liquid crystal phase is 1.2 times or larger the panel gap distance of the liquid crystal device.

[15] A liquid crystal device comprising at least,

a pair of substrates; and

a liquid crystal material disposed between the pair of substrates;

wherein the current passing through the pair of substrates shows substantially no peak-shaped current, when a continuously and linearly changing voltage waveform is applied to the liquid crystal device.

[16]A liquid crystal device according to [15], wherein the liquid crystal material is a the ferroelectric liquid crystal material.

[17] A liquid crystal device according to [15], which shows a monotonic current, when a continuously and linearly changing voltage waveform is applied to the liquid crystal device.

[18] A liquid crystal device according to [15], wherein the continuously and linearly changing voltage waveform is selected from the group consisting of: a triangular waveform, a sine waveform, and a rectangular waveform.

[19]A liquid crystal device according to [15], wherein the liquid crystal molecular alignment treatment for the liquid crystal material is conducted by buffing.

[20] A liquid crystal device according to [19], wherein the liquid crystal molecular alignment treatment for the liquid crystal material is conducted in conjunction with a liquid crystal molecular alignment material providing a low surface pre-tilt angle.

[21] A liquid crystal device according to [20], wherein the low surface pre-tilt angle is 1.5° or less.

[22] A liquid crystal device according to [15], wherein the liquid crystal material shows Smectic A phase to the ferroelectric liquid crystal phase sequence.

[23] A liquid crystal device according to [22], wherein the liquid crystal device has been produced by causing a phase transition from Smectic A phase to a ferroelectric liquid crystal phase, while decreasing the device temperature at a rate of 3° C. per minute or less.

[24] A liquid crystal device according to [23], wherein the phase transition from Smectic A phase to a ferroelectric liquid crystal phase is conducted, while applying an alternative current waveform voltage.

[25] A liquid crystal device according to [24], wherein the alternative current waveform voltage is selected from the group consisting of: a triangular waveform, a sine waveform, and a rectangular waveform voltage.

[26] A liquid crystal device according to [24], wherein the alternative current waveform voltage is applied so as to provide an electric field of 1 V/mm or less in the curse of the phase transition from the Smectic A phase to the Ferroelectric liquid crystal phase;

the alternative current waveform voltage is applied so as to provide an electric field of 1.5 V/mm or less when the temperature is between the phase transition temperature to the Ferroelectric liquid crystal phase, and the temperature which is 10° C. lower than the phase transition temperature;

the alternative current waveform voltage is applied so as to provide an electric field of 5 V/mm or less when the temperature is between the temperature which is 10° C. lower than the phase transition temperature, and the temperature which is 20° C. lower than the phase transition temperature; and

the alternative current waveform voltage is applied so as to provide an electric field of 7.5 V/mm or less when the temperature is 20° C. or more lower than the phase transition temperature.

[27] A liquid crystal device according to [16], wherein the liquid crystal material shows a bookshelf layer structure or quasi-bookshelf structure at the ferroelectric liquid crystal phase.

[28] A liquid crystal device according to [27], wherein the helical pitch at the ferroelectric liquid crystal phase is 1.2 times or larger the panel gap distance of the liquid crystal device.

[29] A liquid crystal device comprising: at least,

a pair of substrates; and

a liquid crystal material disposed between the pair of substrates;

wherein the liquid crystal material shows a bookshelf layer structure or quasi-bookshelf structure at the ferroelectric liquid crystal phase.

[30] A liquid crystal device according to [1], wherein the liquid crystal material is a the ferroelectric liquid crystal material.

[31] A liquid crystal device comprising: at least,

a pair of substrates; and

a liquid, crystal material disposed between the pair of substrates;

wherein each of the pair of substrates has thereon a molecular alignment film having a thickness of 3,000 A or more, which has been subjected to buffing alignment treatment so as to provide a contact length of the buffing alignment treatment of 0.3 mm or more.

Further scope of applicability of the present invention will become apparent from the detailed description given hereinafter. However, it should be understood that the detailed description and specific examples, while indicating preferred embodiments of the invention, are given byway of illustration only, since various changes and modifications within the spirit and scope of the invention will become apparent to those skilled in the art from this detailed description.

### BRIEF DESCRIPTION OF THE DRAWINGS

FIG. 1 is a schematic sectional view showing a typical example of the current RGB sub-pixel structures in the TFT-LCDS.

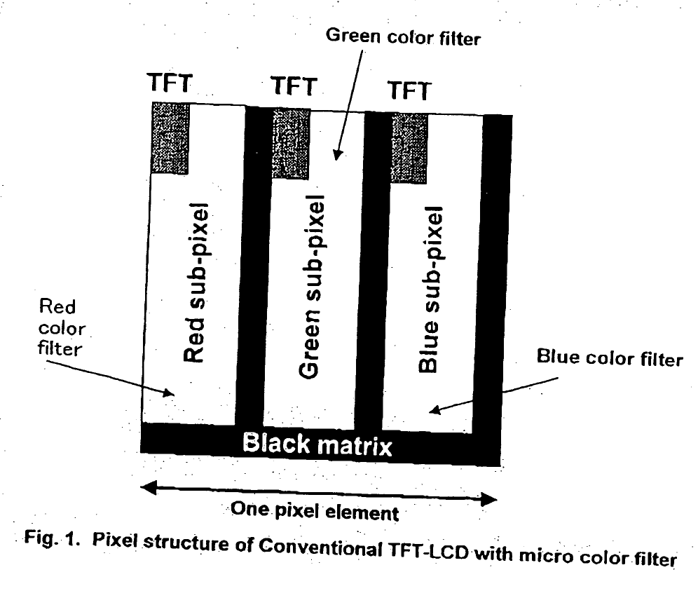

FIG. 2 is a graph showing a proportional relationship between the screen image velocity and the diagonal size.

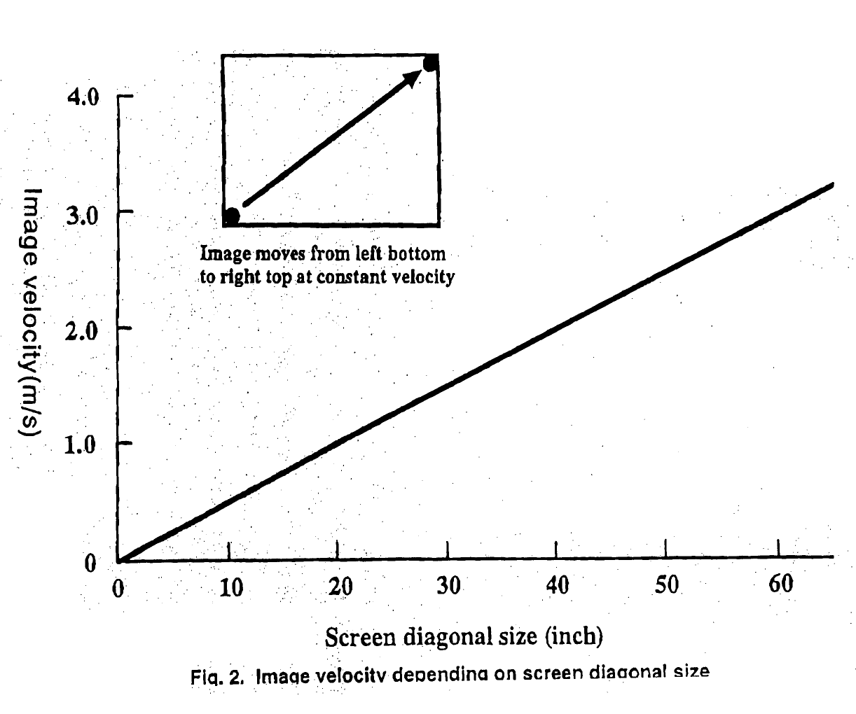

FIG. 3 is a schematic plan view showing a pixel structure of Field Sequential Color PS-V-FLCD.

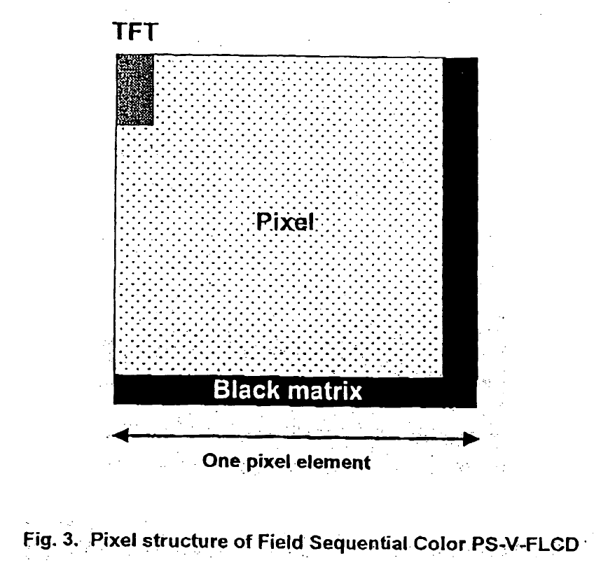

FIG. 4 is a schematic graph showing an example of light throughput efficiency in a field sequential color display. The graph (a) schematically shows an asymmetrical response in the case of nematic liquid crystal. The graph (b) schematically shows a symmetrical response in the case of FLC.

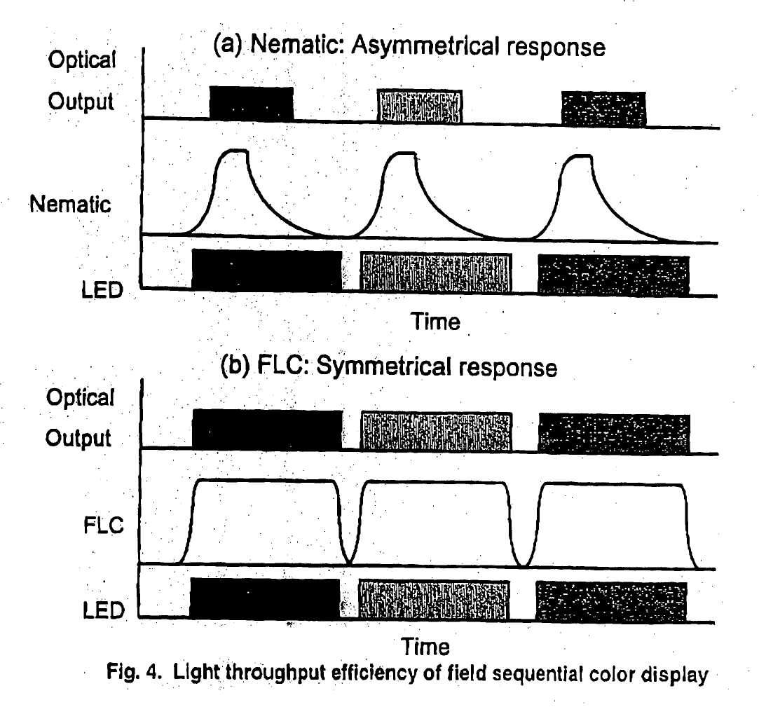

FIG. 5 is a schematic graph showing an extinction angle in a PS-V-FLCD panel.

FIG. 6 is a schematic graph showing an extinction angle in a SSFLCD panel.

FIG. 7 is a view showing an example of analog gray scale response.

FIG. 8 is a schematic perspective view showing a typical example of the initial molecular alignment to be used in the present invention.

FIG. 9 is a schematic perspective view showing a typical example of the initial and switching molecular alignment of SSFLCD.

FIG. 10 is a schematic perspective view for illustrating a typical example of the electro-optical effect of an SSFLC display.

FIG. 11A is a schematic plan view showing a typical example of the initial molecular alignment according to model A (uniform model).

FIG. 11B is a schematic plan view showing a typical example of the initial molecular-alignment according to Model B (internally symmetric model).

FIG. 11C is a schematic plan showing a typical example of the initial molecular alignment according to Model C (total polarization Cancellation model).

FIG. 12 is a graph showing an example of the polarization switching current during molecular orientation switching under an applied triangular waveform voltage.

FIG. 13 is a graph showing an example of the polarization switching peak current during in the case of conventional SSFLCD panel.

FIG. 14A is a schematic view for illustrating c-director profile of PS-V-FLCD.

FIG. 14B is a schematic view for illustrating polarization switching process in the case of SSFLCD.

FIG. 15 is a graph showing an example of the dielectric behavior of SSFLCD and PS-V-FLCD.

FIG. 16 is a graph showing an example of the Difference in the VHR behavior between SSFLCD find PS-V-FLCD.

FIG. 17 is a schematic view for illustrating a buffing (or rubbing) angle of a laminated panel.

FIG. 18 is a view showing a typical example of the Electro-optical effect of a control example.

FIG. 19 is a view showing a typical example electro-optical effect of an embodiment of the device according to the present invention.

### DETAILED DESCRIPTION OF PREFERRED EMBODIMENTS

Hereinbelow, the resent invention will be described in detail with reference to the accompanying drawings, as desired. In the following description, “%” and “part(s)” representing a quantitative proportion or ratio are those based on mass (or weight), unless otherwise noted specifically.

(Liquid Crystal Device)

The liquid crystal device according to an embodiment of the present invention comprises: at least, a pair of substrates; and a liquid crystal material disposed between the pair of substrates. In this liquid crystal device, the molecular initial alignment in the liquid crystal material has an almost parallel direction with respect to the alignment treatment direction; and the liquid crystal material shows substantially no spontaneous polarization which is at least perpendicular to the pair of substrates under the absence of an externally applied voltage.

(Molecular Initial Alignment)

In the present invention, in the molecular initial alignment (or orientation) in the liquid crystal material, the major axis of the liquid crystal molecules has an almost parallel direction with respect to the alignment treatment direction for the liquid crystal molecules. The fact that the major axis of the liquid crystal molecules has an almost parallel-direction with respect to the alignment treatment direction can be confirmed, e.g., by the following manner. In order to enable the liquid crystal device according to the present invention to exhibit a desirable display performance, the angle (absolute value) between the rubbing direction and the alignment direction of the liquid crystal molecules, which has been measured by the following method may preferably be 3° or less, more preferably be 2° or less, particularly 1° or less. In a strict sense, it is known that when a polymer alignment film such as polyimide film is subjected to rubbing, a birefringence is induced in the polyimide outermost layer, to thereby provide a slow optical axis. Further, in general, it is known that the major axis of the liquid-crystal molecules are aligned in parallel with the slow optical axis with respect to almost all of the polymer alignment films, it is known that a certain gap in the angle occurs between the rubbing direction and the slow optical axis. In general, the gap is relatively small and may be about 1-7 degrees., However, this gap in the angle can be 90 degrees as in the case of polystylene as an extreme example. Therefore, in the present invention, the angle between the rubbing direction and the alignment direction of the major axis (i.e. optical axis) of the liquid crystal molecules may preferably be 30 or less. At this time, the alignment direction of the major axis of the liquid crystal molecules, and the slow optical axis which has been provided in the polymer (such as polyimide) polymer alignment film by rubbing, etc., may preferably be 3 degrees or less, more preferably 2 degrees or less, particularly 1 degree or less.

As described above, in the present invention, the alignment treatment direction refers to the direction of the slow optical axis (in the polymer outermost layer) which determines the direction of the alignment of the liquid crystal molecule major axis.

<Method of Measuring Molecular Initial Alignment Atate for Liquid Crystal Molecules>

In general, the major axis of liquid crystal molecules is in fair agreement with the optical axis. Therefore, when a liquid crystal panel is placed in a cross Nicole arrangement wherein a polarizer is disposed perpendicular to an analyzer, the intensity of the transmitted light becomes the smallest when the optical axis of the liquid crystal is in fair agreement with the absorption axis of the analyzer. The direction of the initial alignment axis can be determined by a method wherein the liquid crystal panel is rotated in the cross Nicole arrangement while measuring the intensity of the transmitted light, whereby the angle providing the smallest intensity of the transmitted light can be determined.

<Method of Measuring Parallelism of Direction of Liquid Crystal Molecule Major Axis with Direction of Alignment Treatment>

The direction of rubbing is determined by a set angle, and the slow optical axis of a polymer alignment film outermost layer which has been provided by the rubbing is determined by the kind of the polymer alignment film, the process for producing the film, the rubbing strength, etc. Therefore, when the extinction position is provided in parallel with the direction of the slow optical axis, it is confirmed that the molecule major axis, i.e., the optical axis of the molecules, is in parallel with the direction of the slow optical axis.

(Spontaneous Polarization)

In the present invention, in initial molecular alignment, the spontaneous polarization (which is similar to the spontaneous polarization in the case of a ferroelectric liquid crystal) is not generated, at least with respect to the direction which is perpendicular to the substrate. In the present invention, the “initial molecular alignment providing substantially no spontaneous polarization is the which does not occur” can be confirmed, e.g., by the following method.

<Method of Measuring Presence of Spontaneous Polarization Perpendicular to the Substrate>

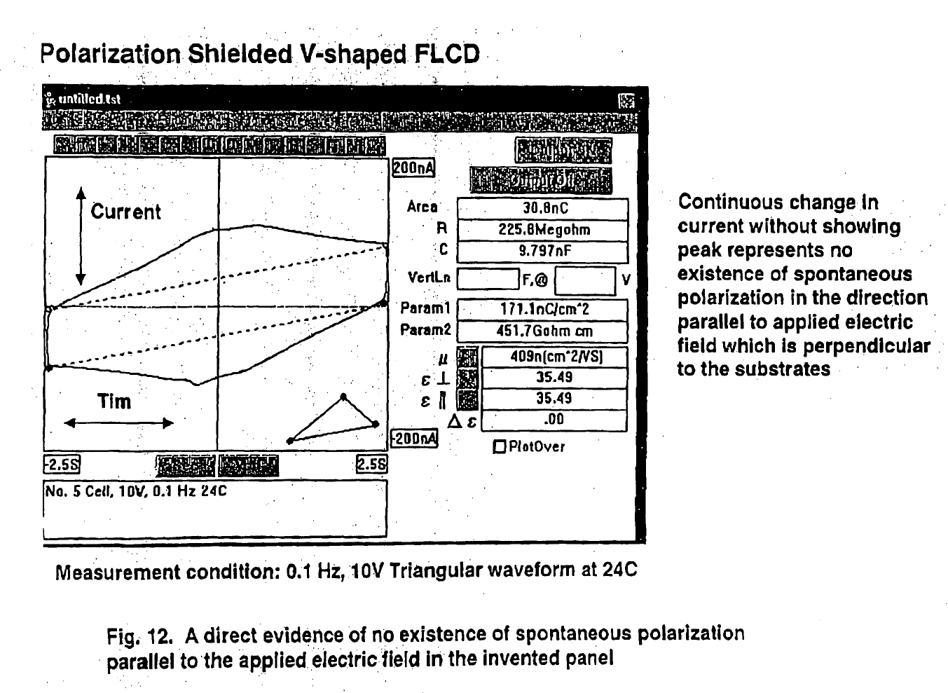

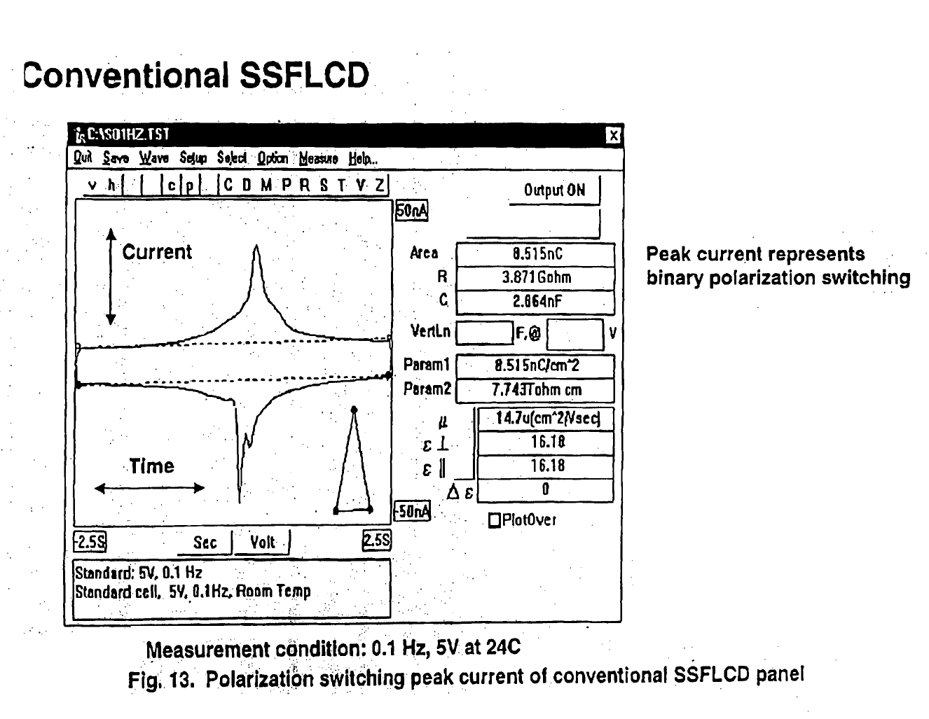

In a case where the liquid crystal in a liquid crystal cell has a spontaneous polarization, particularly in a case where a spontaneous polarization is generated in the substrate direction in the initial state, namely in the direction perpendicular to the electric field direction in the initial state (i.e., in the absence of an external electric-field), when a low-frequency triangular voltage (about 0.1 Hz) is applied to the liquid crystal cell, the direction of the spontaneous polarization is reversed from the upper direction into the lower direction, or from the lower direction into the upper direction, along with the change of the polarity of the applied voltage from positive into negative, or from negative into positive. Along with such an inversion, actual electric charge is transported (i.e., an electric current is generated). The spontaneous polarization is reversed, only when the polarity of the applied electric field is reversed. Therefore, there appears a peak shaped electric current as shown in FIG. 13. The integral value of the peak-shaped electric current corresponds to the total quantity electric charges to be transported, i.e., the strength of the spontaneous polarization. When no peak-shaped electric current is observed in this measurement, the absence of the occurrence of the spontaneous polarization inversion is directly proved by such a phenomenon. Further, when a linear increase in the electric current as shown in FIG. 12 is observed, it is found that the major axis of the liquid crystal molecules is continuously or consecutively changed in the molecular alignment direction thereof, depending on the increase in the electric field intensity. In other words, in this case as shown in FIG. 12, it has been found that there occurs a change in the molecular alignment direction due to induced polarization, etc., depending on the intensity of the applied electric field.

(Substrate)

The substrate usable in the present invention is not particularly limited, as long as it can provide the above-mentioned specific “molecular initial alignment state”. In other words, in the present invention, a suitable substrate can appropriately be selected in view of the usage or application of LCD, the material and size thereof, etc. Specific examples thereof usable in the present invention are as follows.

A glass substrate having thereon a patterned a transparent electrode (such as ITO)

An amorphous silicon TPT-array substrate

A low-temperature poly-silicon TFT array substrate.

A high-temperature poly-silicon TFT array substrate

A single-crystal silicon array substrate.

(Preferred Substrate Examples)

Among these, it is preferred to use following substrate, in a case where the present invention is applied to a large-scale liquid crystal display panel.

An amorphous silicon TFT array substrate

(Liquid Crystal Material)

The liquid crystal material usable in the present invention is not particularly limited as long as it can provide the above-mentioned specific “molecular initial alignment state”. In other words, in the present invention, a suitable liquid crystal material can appropriately be selected, in view of the physical property, electric or display performance, etc. For example, various liquid crystal materials (including various ferroelectric or non-ferroelectric liquid crystal materials) as exemplified in a publication of may generally be used in the present invention. Specific preferred examples of such liquid crystal materials usable in the present invention are as follows.

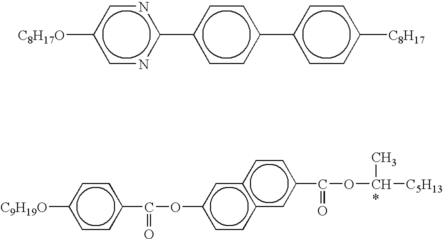

(Preferred Liquid Crystal Material Examples)

Among these, it is preferred to use the following liquid crystal material, in a case where the present invention is applied to a projection-type liquid crystal display.

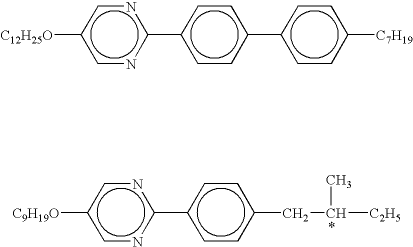

(Alignment Film)

The alignment film usable in the present invention is not particularly limited as long as it can provide the above-mentioned specific “molecular initial alignment state”. In other words, in the present invention, a suitable alignment film can appropriately be selected, in view of the physical property, electric or display performance, etc. For example, various alignment films as exemplified in publications may generally be used in the present invention. Specific preferred examples of such alignment films usable in the present invention are as follows.

Polymer alignment film: polyimides, polyamides, polyamide-imides

Inorganic alignment film: SiO₂, SiO, Ta₂O₅, etc.

(Preferred Alignment Film Examples)

Among these, it is preferred to use the following alignment film, in a case where the present invention is applied to a projection-type liquid crystal display.

Inorganic Alignment Films

In the, present invention, as the above-mentioned substrates, liquid crystal materials, and alignment films, it is possible to use those materials, components or constituents corresponding to the respective items as described in “Liquid Crystal Device Handbook” (1989), published by The Nikkan Kogyo Shimbun, Ltd. (Tokyo, Japan), as desired.

(Other Constituents)

The other materials, constituents or components, such as transparent electrode, electrode pattern, micro-color filter, spacer, and polarizer, to be used for constituting the liquid crystal display according to the present invention, are not particularly limited, unless they are against the purpose of the present invention (i.e., as long as they can provide the above-mentioned specific molecular initial alignment state). In addition, the process for producing the liquid crystal display device which is usable in the present invention is not particularly limited, except the liquid crystal display device should be constituted so as to provide the above-mentioned specific molecular initial alignment state”. With respect to the details of various materials, constituents or components for constituting the liquid crystal display device, as desired, “Liquid Crystal Device Handbook” (1989), published by The Nikkan Kogyo Shimban, Ltd. (Tokyo, Japan) may be referred to.

(Means for Realizing Specific Initial Alignment)

The means or measure for realizing such an alignment state is not particularly limited, as long as it can realize the above-mentioned specific “molecular initial alignment state”. In other words, in the present invention, a suitable means or measure for realizing the specific initial alignment can appropriately be selected, in view of the physical property, electric or display performance, etc.

The following means may preferably be used, in a case where the present invention is applied to a large-sized TV panel, a small-size high-definition display panel, and a direct-view type display.

(Preferred Means for Providing Initial Alignment)

According to the present inventors' investigation and knowledge, the above-mentioned suitable initial alignment may easily be realized by using the following alignment film (in the case of baked film, the thickness thereof is shown by the thickness after the baking) and rubbing treatment. On the other hand, in ordinary ferroelectric liquid crystal displays, the thickness of the alignment film 3,000 A (angstrom) or less, and the strength of rubbing (i.e., contact length of rubbing) 0.3 mm or less.

Thickness of alignment film: preferably 4,000 A or more, more preferably 5,000 A or more (particularly, 6,000 A or more).

Strength of rubbing (i.e., contact length of rubbing): preferably 0.3 mm or more, more preferably 0.4 mm or more (particularly, 0.45 mm or more) The above-mentioned alignment film thickness and strength of rubbing may be measured, e.g., in a manner as described in Example 1 appearing hereinafter

(Comparison of the Present Invention and Background Art)

Herein, for the purpose of facilitating the understanding of the above-mentioned structure and constitution of the present invention, some features of the liquid crystal device according to the present invention will be described in comparison with those having different structures.

The present invention has been provided by detail investigation and analysis of Polymer Stabilized V-shaped FLCD which can have some advantages for small screen with high resolution the LCDs and large screen direct view LCD TV-applications. Next, the basic principles of the Polymer Stabilized V-shaped FLCD is first described, and then some features of the liquid crystal device according to the present invention will be described in comparison with the Polymer Stabilized V-shaped FLCD.

Polymer Stabilized V-Shaped-FLCDs

Polymer Stabilized V-shaped FLCD is described in Application H09-17446,3 wherein a photo-polymerizable liquid crystalline material is mixed with FLC and these materials are polymerized at chiral smectic C phase (ferroelectric liquid crystal phase). This Application H09-174463 discusses this polymerization stabilizes the Ferroelectric liquid crystal layer structure, resulting in the stabilization of the liquid crystal molecular alignment. Also this application teaches that as the result of layer structure stabilization, analog gray scale expressed as V-shaped response in voltage and light transmittance relationship is provided. Here, the “V-shaped” responses means analog gray scale response controlled by applied electric field strength, so that this is equivalent with “V-shaped”. The related investigation with the Application H09-174463-described in Japanese Journal of Applied Physics; “Preliminary Study of Field Sequential Full color The liquid crystal Display using Polymer Stabilized Ferroelectric liquid crystal Display”; Vol. 38, (1999) L534-L536; T. Takahashi, et al., shows half-V shaped optical response which shows analog gray scale optical response only for one polarity applied voltage for instance response only for positive voltage application and no response to negative applied voltage.

There are other reports about V-shape optical response in FLCD and Anti-the ferroelectric liquid crystal display (AFLCD) such as International Display Workshop 2000 in Kobe; “Recent Development of a THE TFT-LCD using Frustrated AFLC”; pp.37-pp.40, T. Yoshida, et al.; and K. H. Yang: “Electro-optical effects of uniform layer tilted state in ferroelectric liquid crystals”, Journal of Applied Physics, 61 (6), pp.2400-pp.2403, 1987.

The present inventor has had detail investigation of mechanism of Polymer Stabilized V-shaped FLCD in conjunction with these related research works, then found actual situation in so-called Polymer Stabilized V-shaped FLCD as discussed hereinbelow. The present inventor's findings clarified that the analog gray scale or —V-shaped optical response in so-called Polymer-Stabilized V-shaped FLCD is not provided by FLC layer structure stabilization from polymerization, but intrinsically from the liquid crystal internal polarization shielding effect. As introduced by the first concept of SSFLCD in the publication; Applied Physics. Letter, “Submicrosecond bistable electro-optic switching in the liquid crystals”; Vol. 36, pp.899-pp.901, 1980; N. A. Clark and S. T. Lagerwall, all of the liquid crystal displays using the ferroelectric liquid crystals have shown a spontaneous polarization perpendicular to the glass substrates sandwich the ferroelectric liquid crystals. Hereinafter, the “polarization shielding effect” means the effect of shielding the ferroelectric liquid crystals polarization perpendicular to the glass substrates. As the result of polarization shielding, the liquid crystal panel prepared by the polarization shielding effect shows no panel internal polarization perpendicular to the glass substrates under the absence of external applied voltage. This situation is very common in the conventional Nematic liquid crystal displays, but not known in the conventional SSFLCDs.

(Analysis of Analog Gray Scale in PS-V-FLCDs)

Hereinbelow, there is described a difference between the liquid crystal device (hereinafter, referred to as “LCD”) according to the above embodiment of the present invention and LCDs in the background art.

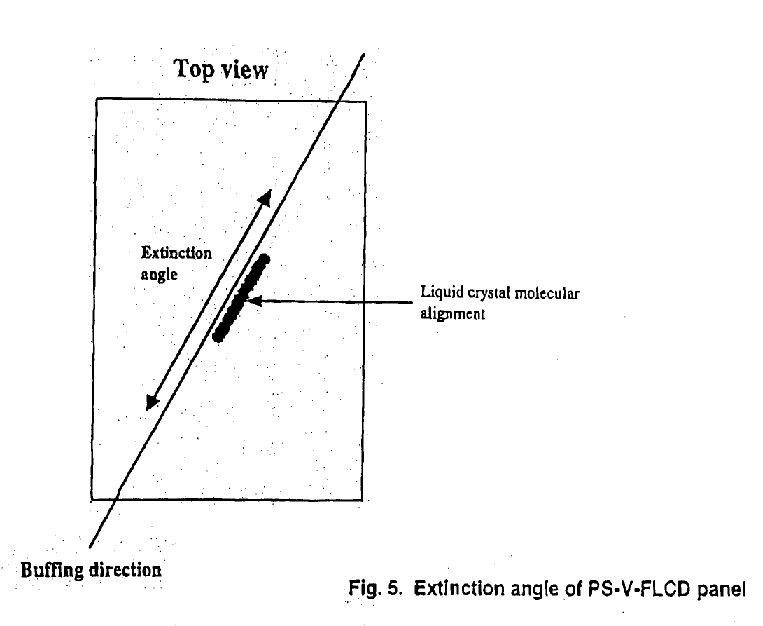

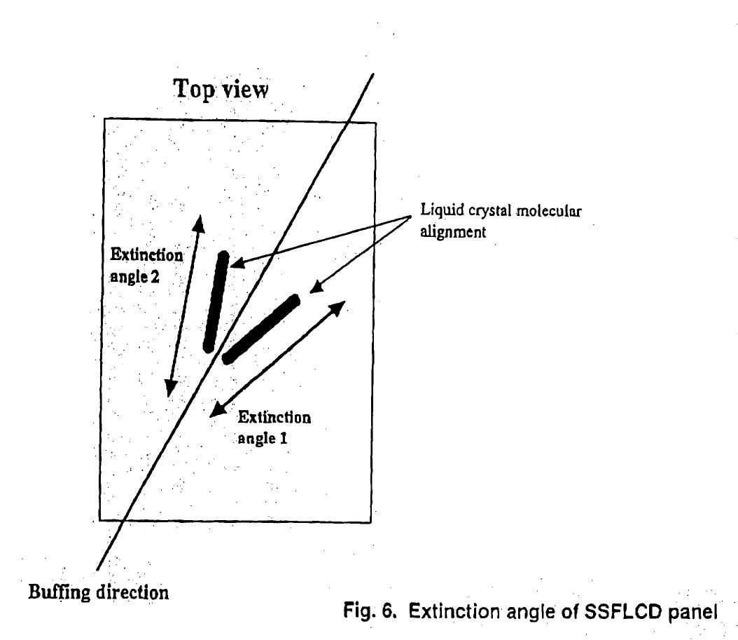

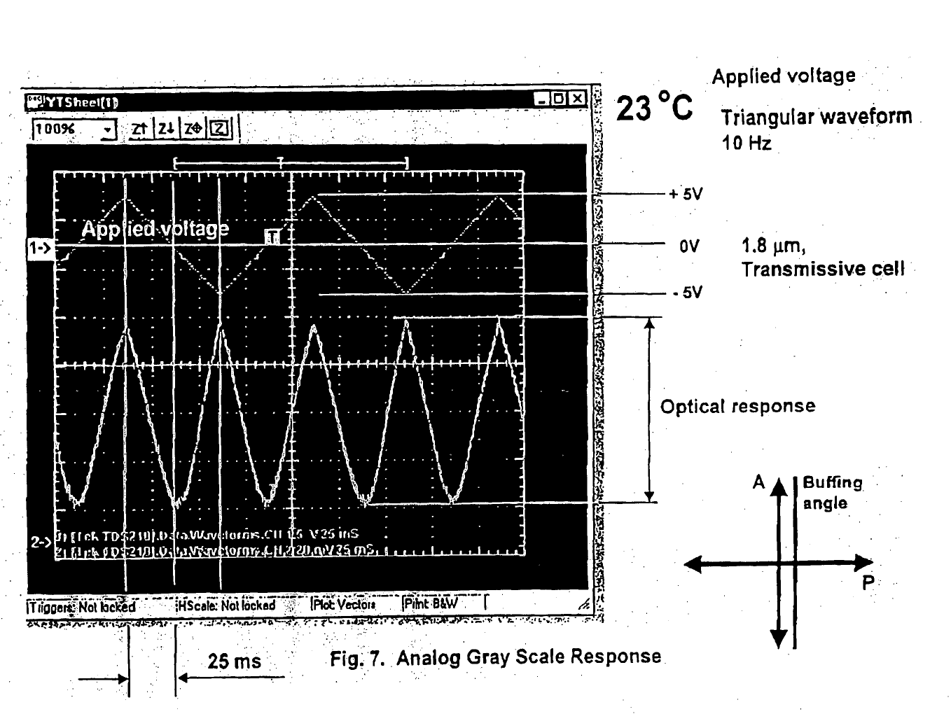

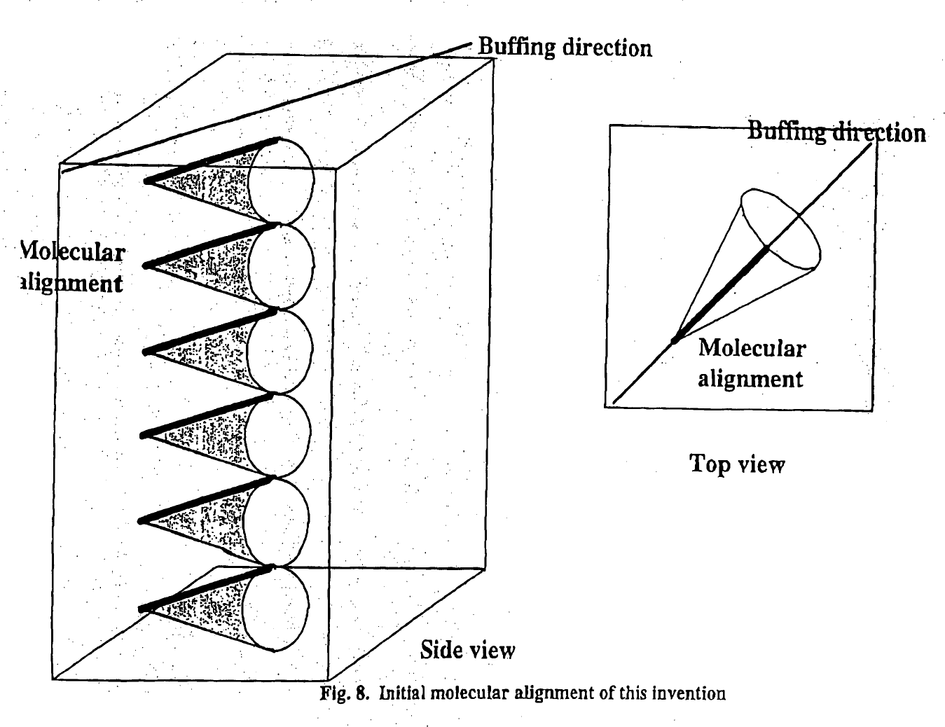

The PS-V-FLCD panel fabricated followed by JP-A (Japanese Unexamined Patent Publication) H11-21554 (corr. to Japanese Patent Application No. H09-174463) has been investigated very seriously, in particular its dynamics in optical response and charge transfer at optical response. As a part of this investigation result, we found this panel has extinction angle parallel to the buffing angle, which is very different from the conventional SSFLCD panel as shown in FIG. 5. Here, the extinction angle is designated as the angle-provides the minimum light transmittance when the buffing angle and polarization absorption angle are set in parallel. Here, the buffing angle is designated as the designed the liquid crystal molecular alignment direction by buffing cloth at the alignment process, which is commonly used as volume production of many types of the liquid crystal displays. The polarization absorption angle is the specific angle to absorb linear polarized light in polarizer film. In the conventional SSFLCD panel, The extinction angle shows some angle from buffing angle as shown in FIG. 6. This angle from buffing angle is very essential in the conventional SSFLCD as described in Applied Physics Letter, “Submicrosecond bistable electro-optic switching in the liquid crystals”; Vol. 36, pp.899-pp.901, 1980; N. A. Clark and S. T. Lagerwall (hereinafter, referred to as “Paper No. 1 by Clarket al.”). This tilt angle from buffing angle is the result from SSFLC molecular alignment. In the PS-V-FLCD panel, the extinction angle parallel to the buffing angle suggests different molecular alignment with the conventional SSFLCD. Next, the initial molecular alignment was investigated from dynamic properties of PS-V-FLCD. FIG. 7 shows electro-optical properties of the PS-V-FLCD panel driven by +/−5V, 10 Hz triangular waveform at room temperature From FIG. 7, the PS-V-FLCD panel responses only for applied voltage magnitude, does not respond for the polarity of applied voltage. This is also very different from the conventional SSFLCD which has only polarity response to the applied voltage. FIG. 7 shows one more very important properties in its dynamic response. When applied voltage changes its polarity from positive to negative and negative to positive, the PS-V-FLCD panel shows minimum transmittance which is almost zero transmittance. This behavior is interpreted that the liquid crystal molecules in the panel pass through the extinction angle every time the applied voltage changes its polarity. From the dynamics of the ferroelectric liquid crystal molecules consideration, the only allowed initial alignment is shown in FIG. 8. FIG. 8 represents that the initial molecular alignment of the S-V-FLCD panel is parallel to the buffing angle. The initial molecular alignment direction parallel to the buffing angle tilts to clockwise direction for instance by applied positive voltage depending on polarization sense of the ferroelectric liquid crystal material, and tilts to counter clockwise direction by applied negative voltage. Applied voltage polarity switching gives minimum transmittance, which is the extinction. The initial molecular alignment shown in FIG. 8 is concluded -32 by the results of dynamic electro-optical measurement. Next, several experiments will be discussed to jutstify the conclusion in FIG. 8.

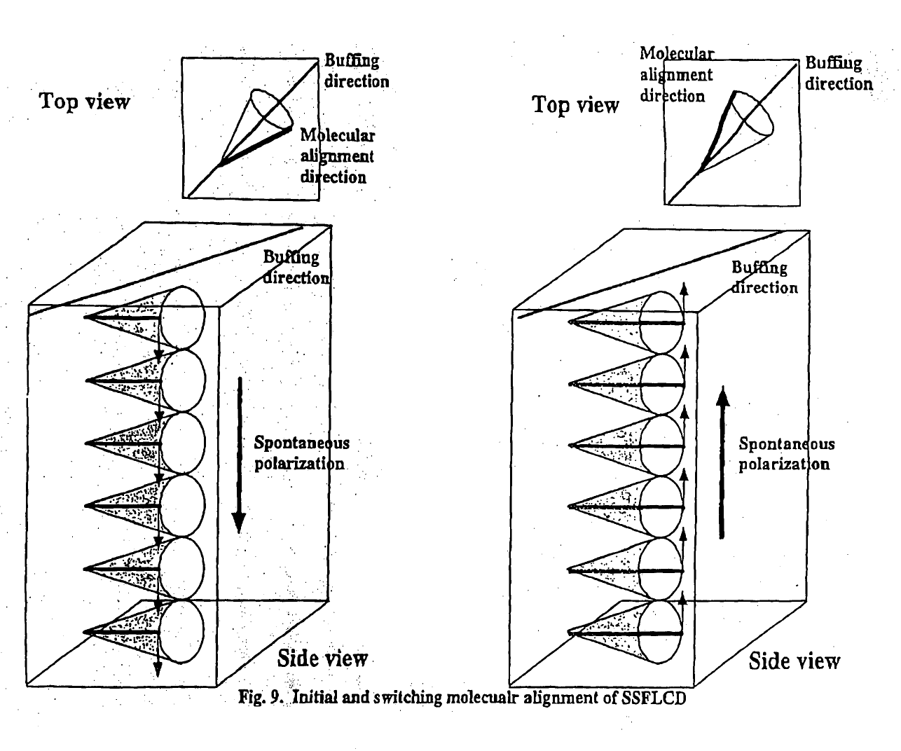

Applied Physics Letter, the above-mentioned Paper No. 1 by Clark et al., says that the conventional SSFLCD panel shows initial molecular alignment as an ideal molecular alignment shown in FIG. 9. As the result of tilted molecular alignment from buffing angle, the panel has spontaneous polarization toward to for instance up in FIG. 9. This spontaneous polarization couples applied voltage, resulting in several hundreds faster optical response than that of current conventional TFT-LCDs.

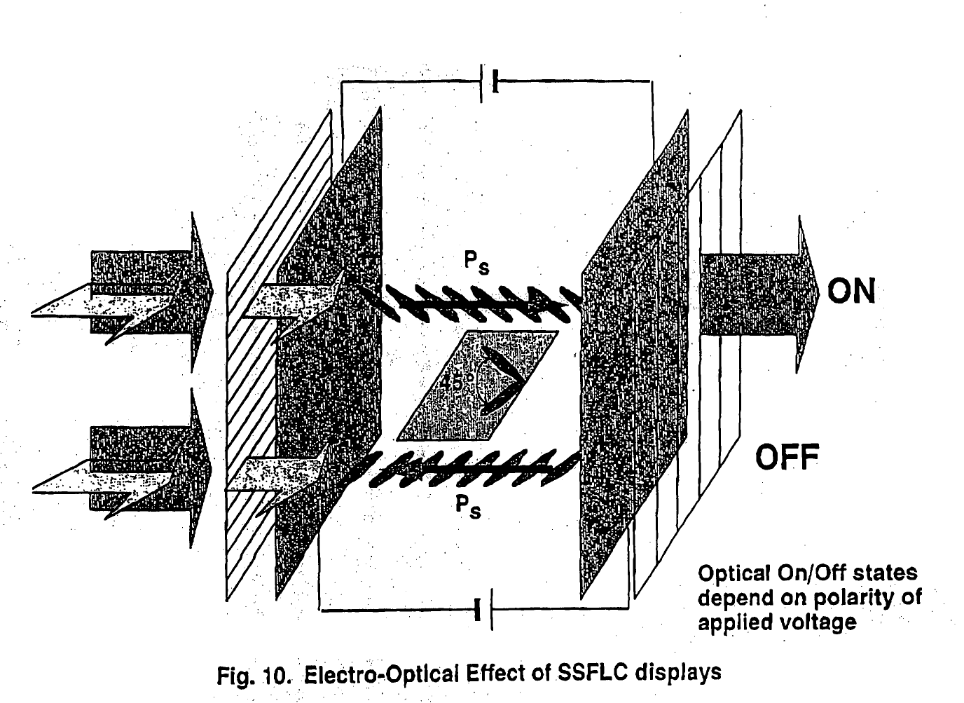

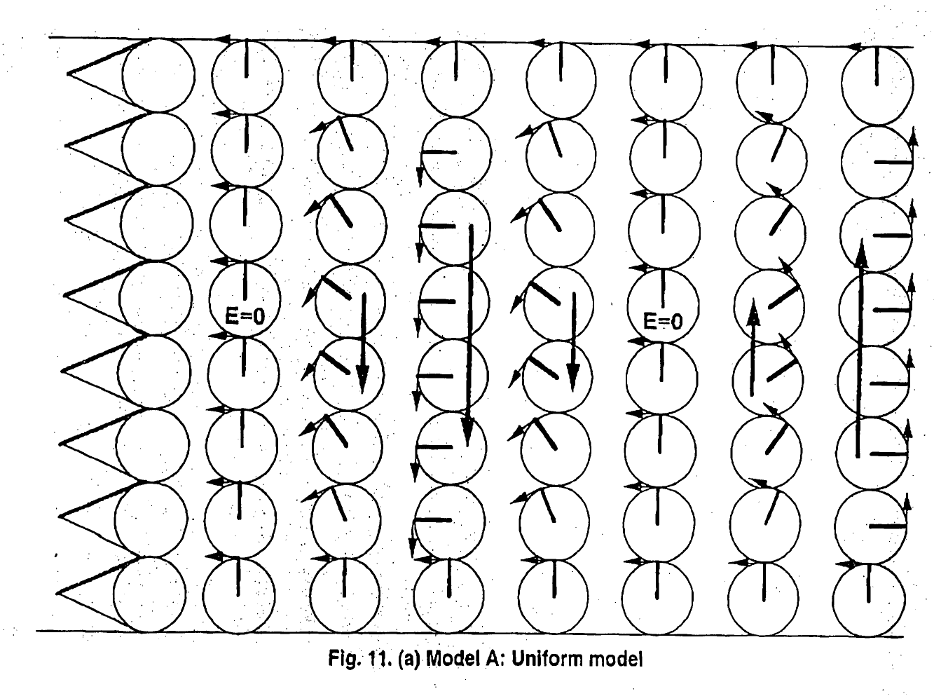

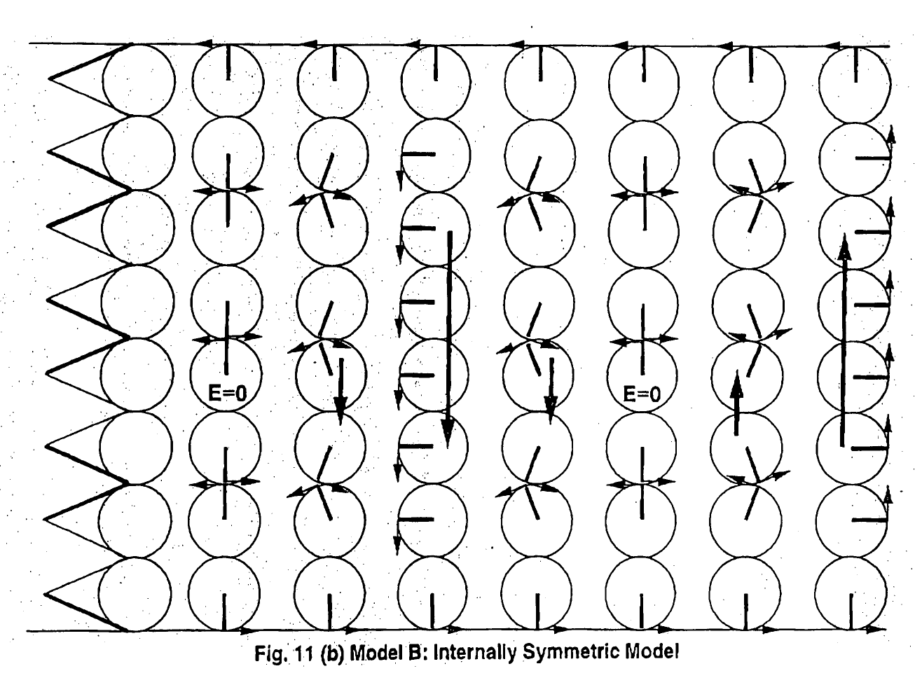

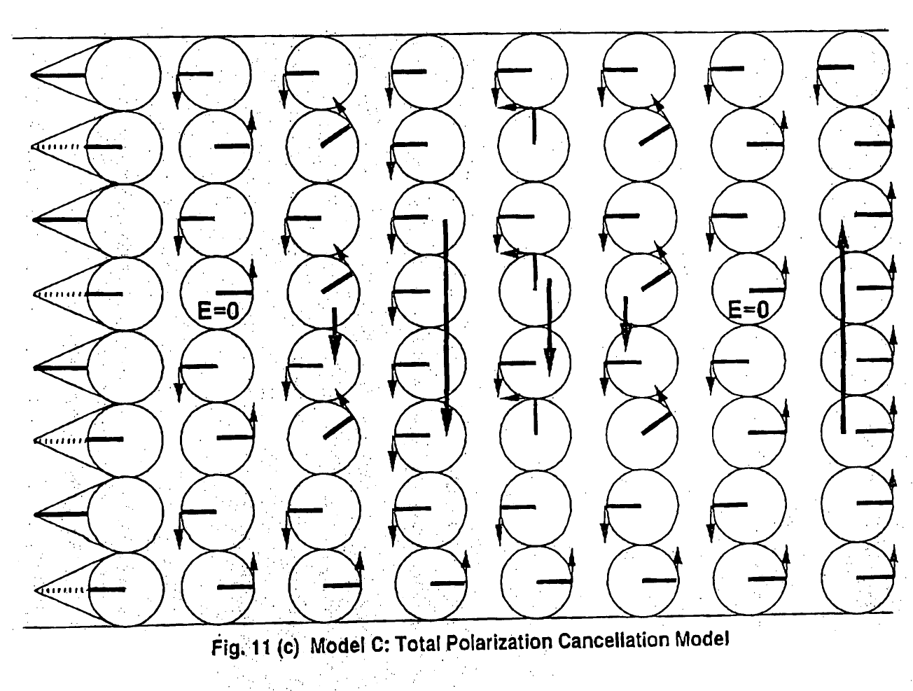

This coupling between spontaneous polarization and applied voltage allows only two ways that are up or down in FIG. 9. This two-way response provides binary response shown in FIG. 10. Therefore, the SSFLCD panel does not have analog gray scale response. As FIG. 9 shows that SSFLC panel always shows spontaneous polarization. This spontaneous polarization is result of tilted molecular alignment from buffing angle. As the conclusion of these discussions, if the panel has no spontaneous polarization under absence of external applied voltage, the only allowed initial molecular alignment is limited in FIG. 11A, 11B, or 11C. Although FIG. 11A, 11B, and 11C show different molecular alignment each other, common thing among these three models is molecular alignment parallel to buffing angle or, parallel to buffing angle as the averaged molecular alignment. All of possible molecular alignment shown in FIG. 11A, 11B, and 11C do not have spontaneous polarization perpendicular to the substrates at least. It is clear that molecular alignment shown in FIG. 11A, 11B, or 11C is not formed in the conventional SSFLCD panel. FIG. 12 shows polarization switching current during molecular orientation switching under the applied triangular waveform voltage.

The conventional SSFLCD panel having spontaneous polarization perpendicular to the substrates shows FIG. 12 like polarization switching peak current. This peak current represents polarization switching of the panel. Before and after the peak current in FIG. 12 correspond to clockwise and counterclockwise molecular tilt from buffing angle in FIG. 8. The PS-V-FLCD panel prepared by JP-A H11-21554 shows FIG. 13 as the same measurement with FIG. 12. This panel shows no polarization switching peak current. FIG. 13 shows direct proof of no polarization perpendicular to the substrates in the PS-V-FLCD panel, and monotonic increase in current shown in FIG. 13 is consistent with continuous change of molecular director alignment which is the analog gray scale. FIG. 13 clarified no spontaneous polarization perpendicular to the substrates at least in the PS-V-FLCD panel. No spontaneous polarization perpendicular to the substrates is only possible in FIG. 11A, 11B, and 11C molecular alignment. Either case in FIG. 11A, 11B, or 11C, common alignment situation is initial molecular alignment is parallel to the buffing direction. This provides the extinction angle at absence of external applied voltage. Therefore, PS-V-FLCD panel realizes normally black type of display. Thanks to the normally black configuration, the black state of PS-V-FLCD panel is independent from ambient temperature change. This reduces temperature dependence of contrast change significantly, which is one of the drawbacks of the conventional SSFLCDs.

As FIG. 13 clarifies, the intrinsic cause of analog gray scale in PS-V-FLCD panel is its monotonic change in molecular director in the panel along with externally applied voltage. This molecular director change is originated from the initial molecular alignment which is parallel to the buffing angle.

With respect to the mechanism of the ferroelectricity exhibition of a so-called ferroelectric liquid crystal, it is said that the free rotation of liquid crystal molecule major axis is obstructed by the steric hindrance of the chiral part, and as a result, there occurs a spontaneous polarization perpendicular to the direction of molecule major axis, which is strong only along a certain direction, to thereby provide the resultant spontaneous polarization. However, there is no certain evidence which shows the obstruction of the free rotation of molecule major axis. On the other hand, the present inventors have found that the free rotation is maintained even in a ferroelectric phase in some cases. As described hereinabove, the ferroelectricity in the ferroelectric liquid crystal is a phenomenon occurring as a result of average of spatial phenomena, unlike that in a typical solid ferroelectric substance. Therefore, in the liquid crystal, it is assumed that the spontaneous polarization is not provided in the entire liquid crystal (bulk) by the physical fixing of the dipole moments of individual liquid crystal molecules. In other words, the present invention is based on a concept that the spontaneous polarization in the conventional liquid crystal is not provided by the sum of the polarization of the individual liquid crystal molecules, but is provided by the sum of the molecular average; and that the spontaneous polarization concerning the entire liquid crystal can be almost zero at the summing step, i.e., the spontaneous polarizations concerning the entire liquid crystal molecules can be obviated by the summing of the spontaneous polarizations.

Next discussion is how this original molecular alignment is prepared. JP-A H11-21554 describes FLC molecular layer structure stabilization by polymer. This patent application discloses that 6 to 10 mass % of photo-polymerization the liquid crystalline material sufficiently stabilizes FLC molecular layer. The used photo-polymerizable the liquid crystalline material has almost same molecular weight with average FLC molecule. Thus, this layer stabilization should be realized by 17 to 20 FLC molecules clipped by one photo-sensitive molecule. Viscous molecule like the liquid crystal is hard to clip its structure as an elastic material by only one molecule for 17 to 20 the liquid crystal molecules. Moreover, layer structure constructing is originated by each the liquid crystal molecular interaction as total free energy of the system. JP-A H11-21554 explains that after the ferroelectric liquid crystal phase is formed, then UV polymerization is fulfilled. This means that after ferroelectric layer structure is formed along with the minimum system free energy, then polymer changes whole system energy for layer structure stabilization. From view point of system free energy, this polymer function is rather destabilizing system free energy. In conclusion, it is very difficult to interpret FLC molecular layer structure stabilization by polymer in JP-A H11-21554 case.

As the result of detail investigation of molecular dynamics and initial orientation, the initial molecular alignment parallel to the buffing direction is thought to be originated from both surface anchoring and bulk the liquid crystal molecular free energy as an elastic material. This discussion does not deny assistance of polymer material in the FLC materials. Difference with JP-A H11-21554 is contribution of polymer material to the particular alignment formation. All of above discussed result represent intrinsic cause of initial molecular alignment parallel to the buffing angle is provided by both surface anchoring interaction and bulk elastic energy of the liquid crystal. Therefore, there should have possibility to realize this particular initial molecular alignment which enables analog gray scale in FLCD just adjustment of both surface anchoring interaction and bulk the liquid crystal elastic energy.

Surface pre-tilt angle adjustment, azimuth anchoring energy, smectic layer forming process, bulk FLC spontaneous polarization which is same as the spontaneous polarization being discussed in this application, and elastic interaction in terms of helical twisting power and panel gap correlation would be major factors to determine the stabilization of this particular initial molecular alignment. One of the examples that show no polymer stabilization is obtaining same phenomenon without using photo-sensitive the liquid crystalline monomer. Even though the photo-sensitive the liquid crystalline monomer is used, in some case, the same phenomenon is obtained before the polymerization. The extinction angle along with buffing angle before polymerization is one of the obvious proofs that the obtained phenomenon is not due to polymer stabilization, but from polarization shielded described above in the present invention. These conditions will be discussed at example experiments of the present invention Next, polarization shielding mechanism is discussed.

(Polarization Blocking Mechanism)

Surface local polarization blocking mechanism by electrostatics effect at specific the liquid crystal materials case is discussed in The liquid crystals, “Electrostatics and the electro-optic behavior of chiral smectic C: ‘block’ polarization screening of applied voltage and ‘V-shaped’ switching”; Vol.27, pp.985-pp.990, (2000); N. A. Clark, et al. (hereinafter, referred to as “Paper No. 2 by Clark et al.”). This specific case requires huge bulk spontaneous polarization such as over 100 nC/cm². This gigantic spontaneous polarization induces surface local polarization block by electrostatics effect. Due to this electrostatics “cancellation” effect, surface local area's electric field is screened. This local screening effect makes continuous gradation of applied electric field, resulting in gray scale response of the liquid crystal panel. Thus, gigantic spontaneous polarization is essential in this case. In the Invention case, very smaller bulk spontaneous polarization materials were used such as less than 30 nC/cm². The present invention case is not a surface local effect, but whole the liquid crystal layer effect as described above. Although the present invention case is obviously different from the gigantic polarization case, electrostatics effect at the interface between alignment material and the liquid crystal is thought to be effective in the present invention case in terms of uniform alignment layer providing strong enough azimuth alignment energy to the liquid crystals. Because in the present invention case, there is no spontaneous polarization perpendicular to the substrates, so that there is no charge up problem in the thicker alignment layer. Moreover, even the bulk total spontaneous polarization is possibly shielded completely in the Invention case as shown some experimental proofs later.

In order to clarify the bulk polarization shielding effect in the Invention case, following three experiments were done. The first experiment was designed to clarify influence of the liquid crystal molecular alignment stability on the polarization shielding effect. FLC material whose bulk spontaneous polarization is 29 nC/cm², and all of process for preparation of the panel was followed by JP-A H11-21554. This FLC material shows very unstable molecular alignment in the conventional FLCD panel. Electro-optical performance of this panel after UV polymerization showed no analog gray scale, but showed binary optical response which is familiar with the conventional SSFLCD panel. Next, using exactly same FLC material and followed by JP-A H11-2154 for the panel fabrication, new panel was prepared. Only difference in the panel preparation was UV polymerization temperature. This panel was polymerized at 0 degree C ambient. After ambient temperature comes back to room temperature, electro-optical response was measured. This panel showed partial analog gray scale. Some area still showed binary response, but over half area showed analog gray scale. The second experiment was designed to clarify surface pre-tilt influence on the polarization shielding effect. The same FLC material used in JP-A H11-21554. All of process except for alignment layer material is exactly same with the JP-A H11-21554. For alignment material, high pre-tilt giving alignment material was used. The typical pre-tilt angle of this alignment material is 6 to 7 degrees. (JP-A H11-21554 uses 1 to 1.5 degree alignment material).

The electro-optical measurement of this panel showed typical binary response. The third experiment was designed to know FLC material influence on polarization shielding effect without using polymerization. Very stable molecular alignment Naphthalene-base FLC material whose smectic layer structure is clarified as bookshelf structure. This material is described in Molecular Crystals and The liquid crystals; A Mochizuki & S. Kobayashi, “Naphthalene-base Ferroelectric liquid crystal and Its Electro Optical Properties”; Vol. 243, pp. 77-pp. 90, (1994). The bulk spontaneous polarization of this Naphthalene-base FLC materials is 35 nC/cm². In this experiment, low pre-tilt of 1 to 1.5 degrees alignment material was used. In this experiment, only this FLC material was used without photo-polymerizable material. When the liquid crystal temperature in the panel changes from temperature of Smectic A phase to Chiral Smectic C phase, temperature reduction rate was set at 1° C./min. In the course of temperature reduction at the rate, triangular waveform of +/−1V, 200 Hz was applied. Also, helical pitch (p) ‘of the Chiral ’ smectic C material and panel gap (d) were set specifically keeping d/p=1.2 or d/p>1.2. The electro optical measurement of this panel showed analog gray scale. This experiment did not use any polymer materials. Detail gray scale measurement is described in Japanese The liquid crystal Conference in Nagoya, “Gray shade capability of SSFLCS by using a bookshelf layer structure FLC”; A. Mochizuki, et al., paper number 3G516, pp.400-pp.401 (1994), (in Japanese).

These three experiments show that analog gray scale obtained in the present invention was not based on polymer stabilization of layer structure described in JP-5. A H11-21554., not based on surface local blocking effect by gigantic: spontaneous polarization in The liquid crystals, “Electrostatics and the electro-optic behavior of chiral smectic C: ‘block’ polarization screening of applied voltage and ‘V-shaped’ switching”; Vol.27, pp985-pp.990, (2000); N. A. Clark, et al. (Paper No. 2 by Clark et al.), but based on the liquid crystal's own molecular alignment stability assisted by low pre-tilt and careful layer structure forming. Moreover, the PS-V-FLCD panel prepared by JP-A H11-21554 shows molecular tilt angle (the maximum tilt angle from initial buffing direction under application of saturated voltage) of over 1.5 times larger than the tilt angle obtained in the conventional SSFLCD configuration. The following Table 2 compares these two tilt angles in each configuration panel, respectively.

TABLE 2
Difference in molecular tilt angle

| | Polarization Shielded | Surface Stabilized |
|---|---|---|
| | V-shaped Ferroelectric | Ferroelectric Liquid |
| Temperature | Liquid Crystal Display | Crystal Display |
| (deg. C.) | Tilt angle (deg.) | Tilt angle (deg.) |
| −10 | 30 | 20 |
| 20 | 36 | 21 |
| 40 | 34 | 19 |
| 60 | 29 | 14 |

In the conventional SSFLCD panel, molecular tilt angle is material parameter, so that molecular tilt angle is independent from panel configuration. However, Table 2 shows very distinct difference between the conventional and PS-V-FLCD particular configuration. The large molecular tilt angle obtained in PS-V-FLCD configuration is interpreted by improvement of smectic layer structure form that is from Chevron layer structure to quasi-bookshelf structure. This means that PS-V-FLCD configuration is obtained by improved layer structure form, which is consistent with improved molecular alignment. This assumption is consistent with the third experimental result using Naphthalene base FLC material.

Now it is clear that the initial molecular alignment parallel to buffing direction is intrinsically realized from the liquid crystal molecular alignment induced by surface pre-tilt and azimuth anchoring energy based on the liquid crystal's own molecular alignment capability. The first experiment is very suggestive in this point. At room temperature, the non stabilized nature of specific the liquid crystal material prevented from its formation of PS-V-FLCD configuration. At lower temperature, where the specific the liquid crystal molecular alignment is improved by suppression of temperature influence (reduction of free energy), even though it was partial effect, but analog gray scale was obtained. The third experimental result is significant in terms of mechanism of PS-V-FLCD. Without using polymer, the third experiment clarified analog ray scale capability, which is the result of polarization shielding. From these discussions, followings are clear. The polarization shielding effect which is necessary to obtain analog gray scale capability in providing FLC is required following conditions: first, FLC material has good alignment property, second, surface pre-tilt should be low, preferably lower than 1.5 degrees, third, the ratio between panel gap and helical pitch of the liquid crystal material is larger than 1.2. Both the second and third conditions are materials parameter. The first one is dependent on panel fabrication process as well as FLC materials own properties. The patent application JP-A H11-21554 uses the first parameter condition as external applied voltage as well as polymerization effect. Therefore, the intrinsic mechanism of analog gray scale capability in providing FLC is provided by Polarization Shielded V-shaped Ferroelectric liquid crystal Display (PS-V-FLCD).

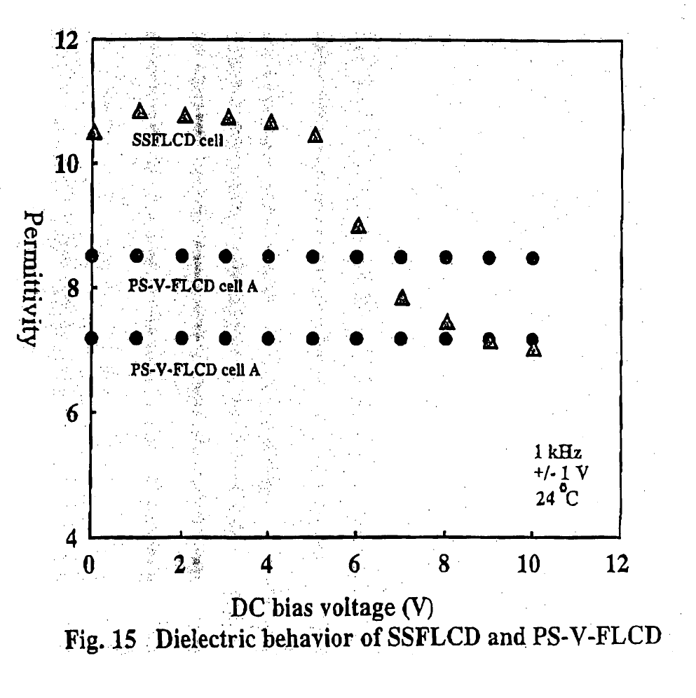

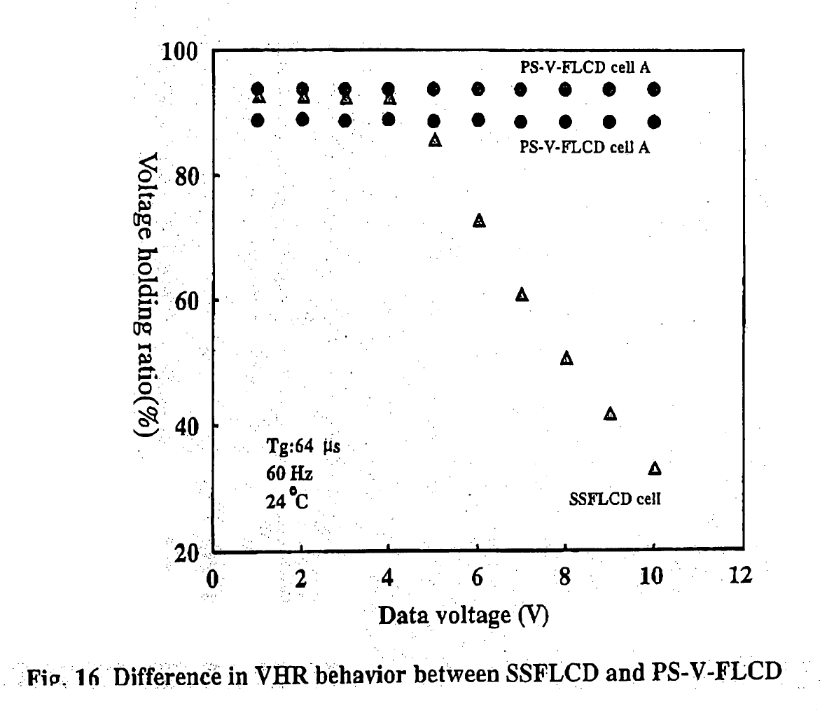

Above discussion, in particular, the mechanism of the analog gray scale of the PS-V-FLCD is endorsed by following couple of experimental data. FIG. 15 shows that no spontaneous polarization is involved in this electro-optical phenomenon at least directly. FIG. 15 describes the capacitance change of the liquid crystal cell under DC bias voltage. As shown at the conventional SSFLCD cell in FIG. 15, due to coupling of spontaneous polarization of the liquid crystal and applied bias voltage, the cell capacitance, which is the result of the permittivity of the liquid crystal inside the cell, changes dramatically along with DC bias voltage application. However, the PS-V-FLCD cases at FIG. 15 show no particular permittivity change by DC bias application. This result strongly suggests no existence of spontaneous polarization at the PS-V-FLCD cells. FIG. 16 indicates more significant result in terms of no involvement of spontaneous polarization. The measurement shown in FIG. 16 is a typical measurement for thin-film transistor (TFT) the LCDS. The voltage holding ratio (VHR) is one of the most important performances for THE TFT-LCDs. The VHR measurement is intrinsically high impedance current measurement, or high impedance Ampere measurement. Due to large charge transfer along with switching of spontaneous polarization, SSFLCD cell shows significant reduction at VHR as shown in FIG. 16. This reduction of the VHR is due to charge transportation from upper electrode to lower electrode or vice versa. It is well known that this charge transportation occurs due to existence of spontaneous polarization. On the contrary, the PS-V-FLCD cells keep almost same VHR after optical response occurs. Both the results in FIGS. 15 and 16 strongly suggest no particular spontaneous polarization involvement at the PS-V-FLCDs. This is consistent with proposed models in the present invention. Therefore, the

Invention described here may be called as “Polarization Shielded Smectic The liquid crystal. Displays, or PSS-the LCDS”.

Analog gray scale capability in providing FLC, which is the most necessary to realize small screen high resolution displays and large screen direct view TVs, requires original molecular alignment parallel to buffing angle. The necessary condition to obtain this original alignment is low pre-tilt at the surface of alignment layer, specific relationship between panel gap and helical pitch, and high stable molecular alignment properties of FLC material. Also assisting condition of external applied voltage to stabilize FLC molecular alignment, slow cooling for stable layer forming, and using polymer are helpful to realize original molecular alignment parallel to the buffing direction.

Strong azimuth anchoring energy is some times effective, but some times not effective to obtain the original molecular alignment. Important thing is good balance between azimuth anchoring energy and FLC, layer structure stability. The layer-structure forming and surface azimuth anchoring energy is somewhat confliction factor.

(Another Embodiment 1)

According to another embodiment, there is provided:

a liquid crystal device comprising at least,

a pair of substrates,

a liquid crystal material disposed between the pair of substrates; and

a pair of polarizing films disposed on the outside of the pair of substrates;

wherein one of the pair of polarizing films has a molecular initial alignment which is parallel or almost parallel with the alignment treatment direction for the liquid crystal material;

the other of the pair of polarizing of films has a polarizing absorption direction which is perpendicular to the alignment treatment direction for the liquid crystal material; and

the liquid crystal device shows an extinction angle under the absence of an externally applied voltage.

The liquid crystal display according to such an embodiment has an advantage that the extinction position thereof does not substantially have a temperature dependency, in addition to those as described above. Therefore, in this embodiment, it is possible to make the temperature dependency of the contrast ratio relatively small.

In the above-mentioned relationship wherein the polarizing absorption axis direction of the polarizing film is substantially aligned with the alignment treatment direction of the liquid crystal material, the angle between the polarizing absorption axis direction of the polarizing film and the alignment treatment direction of the liquid crystal material may preferably be 2° or less, more preferably 1° or less, particularly 0.5 or less.

In addition, the phenomenon that the liquid crystal device shows an extinction position, in the absence of an externally applied voltage may be confirmed, e.g., by the following method.

<Method of Confirming Extinction Position>

A liquid crystal panel to be examined is inserted between a polarizer and an analyzer which are arranged in a cross-Nicole relationship, and the angle providing the minimum light quantity of the transmitted light is determined while the liquid crystal panel is being rotated. The thus determined angle is the angle of the extinction position.

(Another Embodiment 2)

According to a further embodiment, there is provided:

a liquid crystal device comprising: at least,

a pair of substrates; and

a liquid crystal material disposed between the pair of substrates;

wherein the current passing through the pair of substrates shows substantially no peak-shaped current, when a continuously and linearly changing voltage waveform is applied to the liquid crystal device.

The current passing through the pair of substrates does not substantially show a peak-shaped current, under the application of a voltage waveform of which strength is continuously and linearly changed, may be confirmed, e.g., by the following method. In this embodiment, “the current does not substantially show a peak-shaped current” means that, in the liquid crystal molecule alignment change, the spontaneous polarization does not participate in the liquid crystal molecule alignment change, at least in a direct manner. The liquid crystal display according to such an embodiment has an advantage, in addition to those as described above, that it enables sufficient liquid crystal driving, even in a device having the lowest electron mobility such as amorphous silicon TFT array device among active driving devices. Even when the liquid crystal per se can exhibit a considerably high display performance, if the capacity thereof is relatively large, it is difficult to drive such a liquid crystal by using an amorphous silicon TFT array device having a limit on the electron mobility. As a result, it is actually impossible to provide high-quality display performance. Even in this case, in view of the ability of driving the liquid crystal, it is possible to provide sufficient display performance, by using low-temperature polysilicon and high-temperature polysilicon TFT array devices having a lager electron mobility than amorphous silicon; or single crystal silicon (silicon wafer) capable of providing the maximum electron mobility. On the other hand, the amorphous silicon TFT array is economically advantageous in view of the production cost. Further, when the size of the panel is increased, the economic advantage of the amorphous silicon TFT array is much greater than the other types of active devices.

<Method of Confirming Peak-Shaped Current>

A triangular wave voltage having an extremely low frequency of about 0.1 Hz is applied to a liquid crystal panel to be examined. The liquid crystal panel would sense such an applied voltage so that a DC voltage is increased and decreased almost linearly. When the liquid crystal in the panel shows a ferroelectric liquid crystal phase, the optical response, and charge transfer state are dependent on the polarity of the triangular wave voltage, but not substantially dependent on the crest value (or peak-to-peak value) of the triangular wave voltage. In other words, the due to the presence of the spontaneous polarization, the spontaneous polarization of the liquid crystal is coupled with the externally applied voltage, only when the polarity of the applied voltage is changed from negative to positive, or from positive to negative. When the spontaneous polarization is reversed, electric charges are temporarily transferred so as to generate a peak-shaped electric current in the inside of the panel. On the contrary, if the reverse of the spontaneous polarization does not occur, no peak-shaped electric current is observed, and the current shows a monotonous increase, decrease or a constant value. Therefore, the polarization of the panel may be determined by applying a low-frequency triangular wave voltage to the panel and precisely measure the resultant current, to thereby determine the profile of the current waveform.

(Another Embodiment 3)

According to a further embodiment of the present invention, there is provided: a liquid crystal device wherein the liquid crystal molecular alignment treatment for the liquid crystal material is conducted in conjunction with a liquid crystal molecular alignment material providing a low surface pre-tilt angle. In this embodiment, the pre-tilt angle may preferably be 1.5° or less, more preferably 1° or less (particularly 0.5° or less). The liquid crystal display according to such an embodiment has an advantage, in addition to those describe above, that it can provide uniform alignment in a wide area, and a wide view angle The reason why the wide view angle is provided is as follows.

In the liquid crystal molecule alignment according to the present invention, liquid crystal molecules may be moved within cone-like regions, and the electro-optical response thereof does not remain in the same plane.

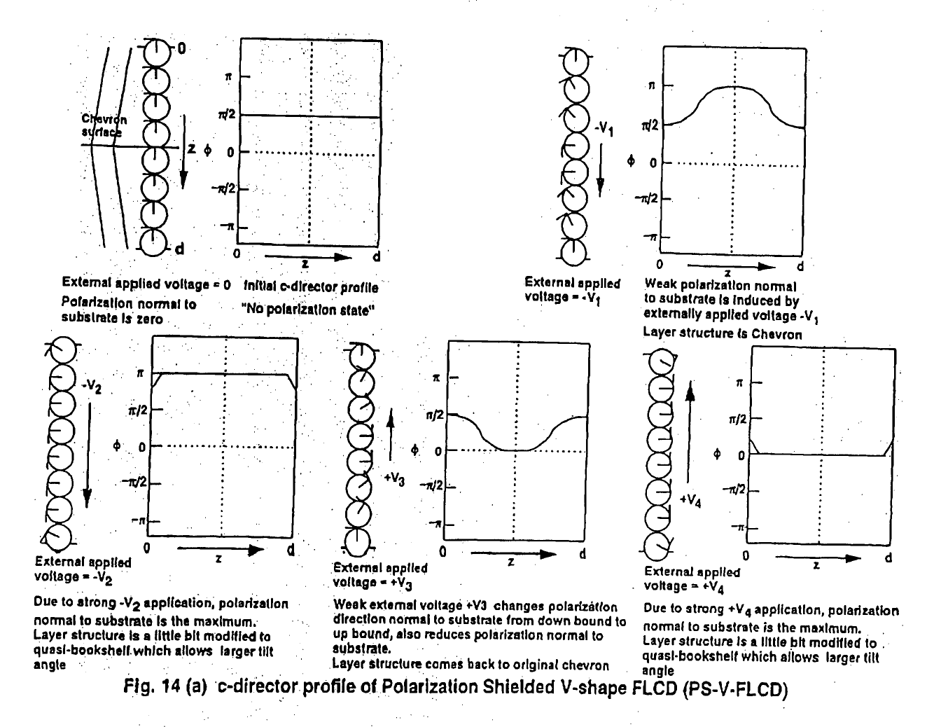

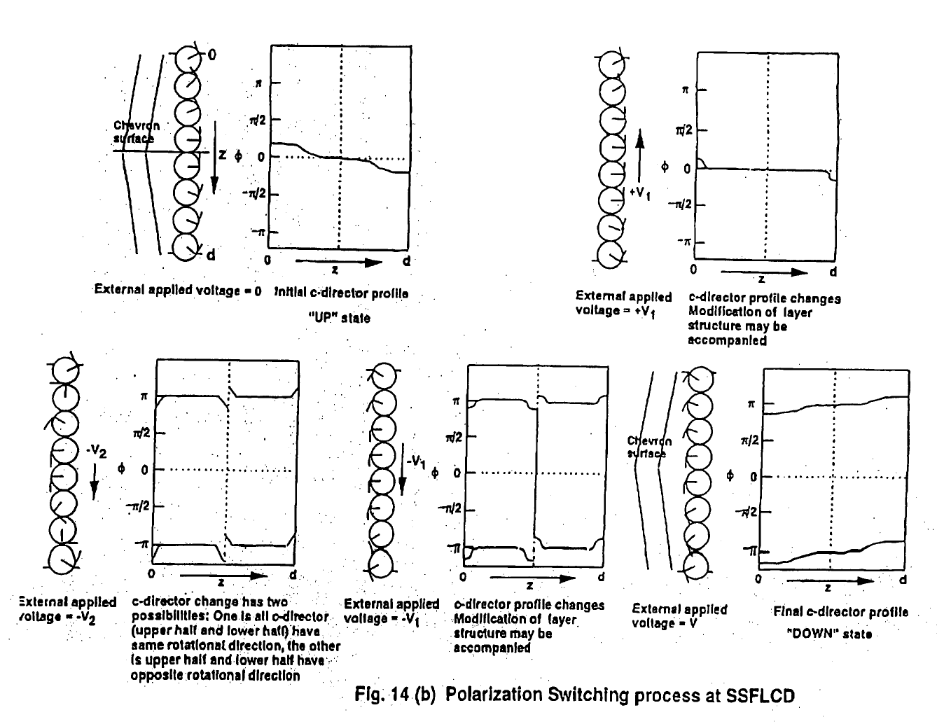

Generally, when such molecular movement out of the plane is caused, the incidence angle dependency of birefringence occurs, and the viewing angle is narrowed However, in the liquid crystal molecule alignment according to the present invention, the molecular optical axis of liquid crystal molecules may always be moved in the clockwise or counter-clockwise direction, symmetrically and at a high-speed, with respect of the top of cones, as shown in FIG. 14A. Due to the high-speed; symmetrical movement, an extremely symmetrical images maybe obtained as a result of time averaging Therefore, with respect to the vexing angle, this embodiment can provide images having high a symmetry and a small angle dependency.

(Another Embodiment 4)

According to a further embodiment of the present invention, there is provided:

a liquid crystal device wherein the liquid crystal material shows Smectic A phase to the ferroelectric liquid crystal phase sequence.

In this embodiment, the phenomenon that the liquid crystal material has a “Smectic A phase to the ferroelectric liquid crystal phase sequence” can be confirmed, e.g., by the following method. The liquid crystal display according to such an embodiment has an advantage, in addition to those as described above, that it can provide a higher upper limit of the storage temperature therefor. More specifically, in a case where the upper limit of the storage temperature for the liquid crystal display is intended to be determined, even when the temperature exceeds the transition temperature for the ferroelectric liquid crystal phase to Smectic A phase, it can return to the ferroelectric liquid crystal phase so as to restore the initial molecular alignment, unless the temperature exceeds the transition temperature for the smectic A phase to cholesteric phase.

<Method of Confirming Phase Transition Sequence>

The phase transition sequence of the smectic liquid crystal may be confirmed as follows.

Under a cross Nicole relationship, the temperature of a liquid crystal panel is lowered from the isotropic phase temperature. At this time, the buffing direction is made in parallel with the analyzer. As a result of the observation by a polarizing microscope, a birefringence change wherein a firework-like shape is changed into a round shape is first measured. When the temperature is further decreased, an extinction direction occurs in parallel with the buffing direction. When the temperature is further decreased, and the phase is converted into a so-called ferroelectric liquid crystal phase. In this phase, when the panel is rotated by an angle of 3-4° around in the vicinity of the extinction position, it is found that the transmitted light intensity is increased when the position is outside of the extinction position, along with a decrease in the temperature.

(Another Embodiment 1 for Producing Device)

According to another embodiment of the production process according to the present invention, it is preferred that:

a liquid crystal device wherein the liquid crystal device has been produced by causing a phase transition from Smectic A phase to a ferroelectric liquid crystal phase, while decreasing the device temperature at a rate of 3° C. per minute or less.

The process for producing the liquid crystal display according to such an embodiment has an advantage, in addition to those described above, that it enables uniform liquid crystal molecule alignment may be provided over the a wide area.

(Another Embodiment 2 for Producing Device)

According to a further embodiment of the production process according to the present invention, it is preferred that:

a liquid crystal device wherein the phase transition from Smectic A phase to a ferroelectric liquid crystal phase is conducted, while applying an alternative current waveform voltage.

The process for producing the liquid crystal display according to such an embodiment has an advantage, in addition to those described above, that it generally enables the enhancement of the uniformity of the liquid crystal molecule alignment. The AC voltage waveform which is to be applied to the device at this time may preferably be one selected from triangular waveform, sine waveform, or rectangular waveform, in view of the uniformity of the liquid crystal molecule alignment.

(Another Embodiment 3 for Producing Device)

According to a further embodiment of the production process according to the present invention, it is preferred that:

a liquid crystal device wherein the alternative current waveform voltage is applied so as to provide an electric field of 1 V/mm or less in the course of the phase transition from the Smectic A phase to the Ferroelectric liquid crystal phase;

the alternative current waveform voltage is applied so as to provide, an electric field of 1.5 V/mm or less when the temperature is between the phase transition temperature to the Ferroelectric liquid crystal phase, and the temperature which is 10° C. lower than the phase transition temperature;

the alternative current waveform voltage is applied so as to provide an electric field of 5 v/mm or less when the temperature is between the temperature which is 10° C. lower than the phase transition temperature, and the temperature which is 20° C. lower than the phase transition temperature; and

the alternative current waveform voltage is applied so as to provide an electric field of 7.5 V/mm or less when the temperature is 20° C. or more lower than the phase transition temperature.

The process for producing the liquid crystal display according to such an embodiment has an advantage, in addition to those described above, that it can increase the contrast ratio.

(Another Embodiment 4 for Producing Device)

According to a further embodiment of the production process according to the present invention, it is preferred that:

a liquid crystal device comprising: at least,

a pair of substrates; and

a liquid crystal material disposed between the pair of substrates;

wherein the liquid crystal material shows a bookshelf layer structure or quasi-bookshelf structure at the ferroelectric liquid crystal phase.

The process for producing the liquid crystal display according to such an embodiment has an advantage, in addition to those described above, that it can provide a high transmittance.

Herein, it is possible to confirm the herical pitch of a ferroelectric liquid crystal phase and the panel gap of the substrates, e.g., by the following method.

<Method of Confirming Herical Pitch>

In a cell having substrates which have been buffed so as to provide alignment treatments in parallel with each other, a liquid crystal material is injected between panels having a cell gap which is at least five times the expected herical pitch. As a result, a striped pattern corresponding to the herical pitch appears in the display surface.

<Method of Confirming Panel Gap>

Before the injection of a liquid crystal material, the panel gap may be measured by using a liquid crystal panel gap measuring device utilizing light interference.

Hereinbelow, the present invention will be described in more detail with reference to specific Examples.

### EXAMPLES

### Example 1

Using commercially available FLC mixture material (Merck: ZLI-4851-100), photo-curable the liquid crystalline material (Dai Nippon Ink Chemicals: UCL-001), and photo initiator material (Merck: Darocur 1173) based on JP-A H11-21554 (Japanese Paten Appln. H09-174463), PS-V-FLCD panel was fabricated. The mixture had 93 mass % of ZLI-4851-100 FLC mixture, 6 mass % of UCL-001, and 1 mass % of Darocur 1173.

The substrate used herein was a glass substrate (borosilicate glass, thickness 0.7 mm, size: 50 mm×50 mm; available from Nono Loa Inc.) having thereon an ITO film.

The polyimide alignment film was formed by applying a polyimide alignment material by use of a spin coater, then preliminarily baking the resultant film, and finally baking the resultant product in a clean oven. With respect to the details of the general industrial procedure to be used herein, as desired, a publication “Liquid Crystal Display Techniques” Sangyo Tosho (1996, Tokyo), Chapter 6 may be referred to.

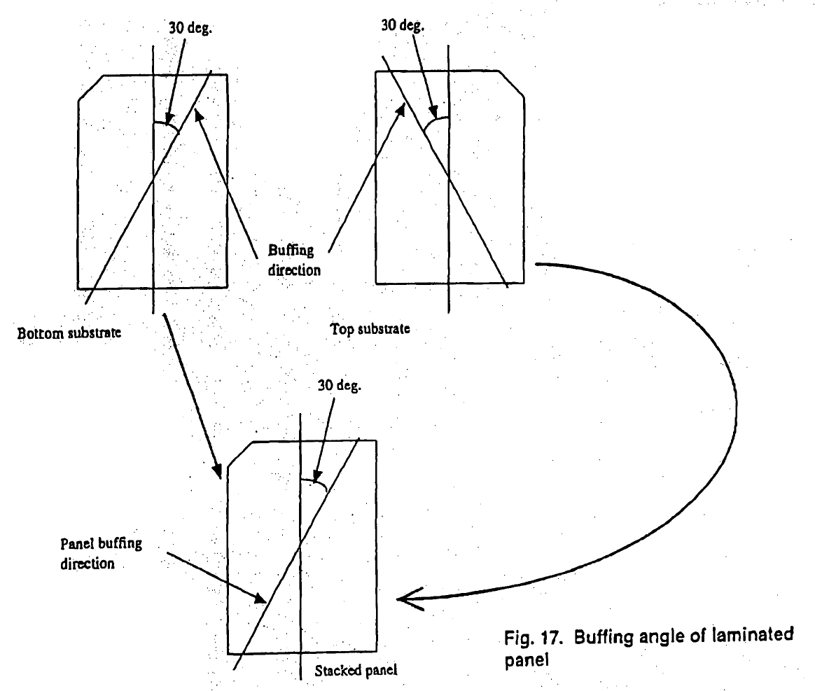

For the liquid crystal molecular alignment material, RN-1199 (Nissan Chemicals Industries) was used as 1 to 1.5° of pre-tilt angle alignment material. Thickness of the alignment layer as cured layer was set at 4,500A to 5000A. The surface of this cured alignment layer was buffed by Rayon cloth (mfd. by Yoshikwa Kako, trade name 19RY) in the direction of 30° to center line of the substrate shown in FIG. 17. The contact length of the buffing was set to 0.5 mm at both substrates.

<Buffing Conditions>

Contact length of the buffing: 0.5 mm

Number of buffing: once

Stage moving speed: 2 mm/sec.

Roller rotational frequency: 1000 rpm (R=40 mm)

Silicon dioxide balls with average diameter of 1.6 μm are used as space. Obtained panel gap as measured was 1.8 μm. The above mixed material was injected into the panel at the isotropic phase temperature of 110° C. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes (by use of a function generator, mfd. by NF Circuit-Block Co., trade name: WF1946F). After 10 minutes voltage application, 365 nm of UV light was exposed keeping application of the same voltage (by use of a UV light, mfd. by UVP Co., trade name: UVL-56). The exposure power was set to 5,000 mJ/cm². With respect to the details of the general industrial: procedure to be used herein, as desired, a publication “Liquid Crystal Display Techniques” Sangyo Tosho (1996, Tokyo), Chapter 6 may be referred to.

The initial molecular alignment direction of this panel was same with the buffing direction. The electro-optical measurement of this panel showed analog gray scale by application of triangular waveform voltage.

With respect to the details of the general industrial procedure to be used herein, as desired, a publication “The optics of Thermotropic Liquid Crystals” Taylor and Francis: 1998, London UK; Chapter 8 and Chapter 9 may be referred to.

### Reference Example 1

(Control)

As same as the example of 5.1, commercially available FLC mixture material (Merck: ZLI-4851-100), photo-curable the liquid crystalline material (Dai Nippon Ink Chemicals: UCL-001), and photo initiator material (Merck: Darocur 1173) based on JP-A R11-21554, PS-V-FLCD panel was fabricated. The mixture had 93 mass % of ZLI-4851-100 FLC-mixture, 6 mass % of UCL-001, and 1 mass % of Darocur 1173. For the liquid crystal molecular alignment material, RN-1199 (Nissan Chemicals Industries) was used as 1 to 1.5° of pre-tilt angle alignment material. Thickness of the alignment layer as cured layer was set at 150A to 200A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm.

The above mixed material was injected into the panel at the isotropic phase temperature of 110. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes. After 10 minutes, voltage application, 365 nm of UV light was exposed keeping application of the same voltage. The exposure power was set to 5,000 mJ/cm². The initial molecular alignment direction of this panel was partially same with the buffing direction, however, most of the viewing area showed +/−20 deg. Shifted from the buffing angle.

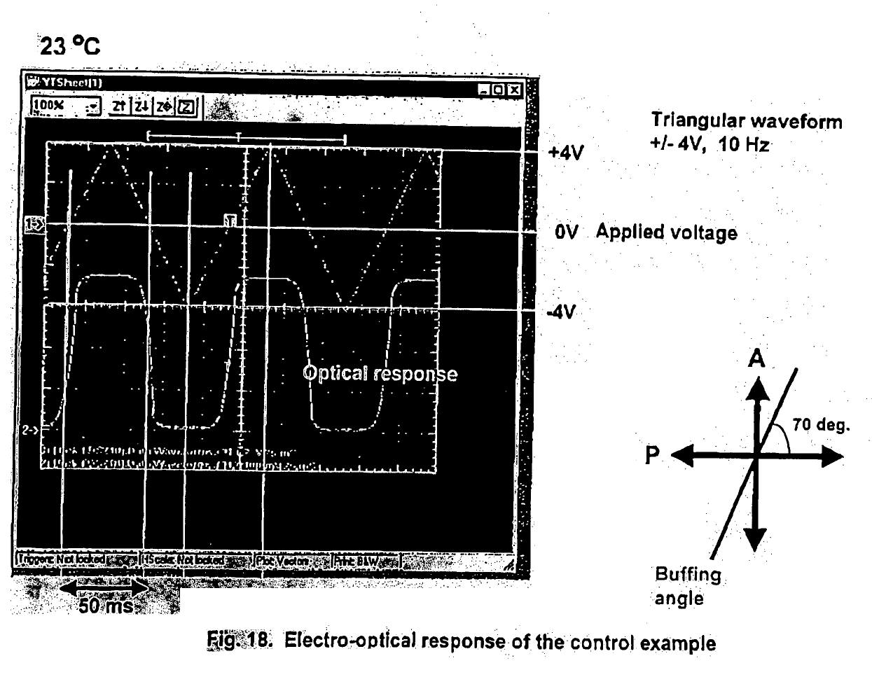

The electro-optical measurement of this panel showed binary domain switching which is popular in the conventional SSFLCD panel as ×20 magnification field average at polarized microscope observation as shown in FIG. 18.

### Reference Example 2

(Control)

As same as the example of 5.1, commercially available FLC mixture material (Merck: ZLI-4851-100), photo-curable the liquid crystalline material (Dai Nippon Ink Chemicals: UCL-001), and photo initiator material (Merck; Darocur 1173) based on JP-A H11-21554, PS-V-FLCD panel was fabricated. The mixture had 93 mass % of ZLI-4851-100 FLC mixture, 6 mass % of UCL-001, and 1 mass % of Darocur 1173. For the liquid crystal molecular alignment material, RN-1199 (Nissan Chemicals Industries) was used as 1 to 1.5° of pre-tilt angle alignment material. Thickness of the alignment layer as cured layer was set at 4,500A to 5,000A. The surface of this cured alignment layer was buffed by Rayon cloth in the direction of 30° to center line of the substrate shown in FIG. 17. The contact length of the buffing was set to 0.1 mm at both substrates. Silicon dioxide balls with average diameter of 1.6 μm are used as space. Obtained panel gap as measured was 1.8 μm. The above mixed material was injected into the panel at the isotropic phase temperature of 110° C. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes. After 10 minutes voltage application, 365 nm of UV light was exposed keeping application of the same voltage. The exposure power was set to 5,000 mJ/cm². The initial molecular alignment direction of this panel was mixed with the buffing direction and +/−20 deg. Shifted from the buffing angle. The electro-optical measurement of this panel showed binary domain switching which is popular in the conventional SSFLCD panel as ×20 magnification field average at polarized microscope observation and did not show analog gray scale.

### Example 2

For the liquid crystal molecular alignment material, RN-1199 (Nissan Chemicals Industries) was used as 1 to 1.5° of pre-tilt angle alignment material. Thickness of the alignment layer as cured layer was set at 6,500A to 7,000A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm, In this panel, commercially available FLC mixture material (Merck: ZLI-4851-100) was injected at the isotropic phase temperature of 110° C. After the mixed material was injected, ambient temperature was controlled to reduce 1° C. per minute till the FLC material showed ferroelectric phase (40° C.). In this slow cooling process, from Smectic A phase to Chiral Smectic C phase (75° C. to 40° C.), +/−2 V, 506 Hz of triangular waveform voltage was applied. After panel temperature reached 40° C., applied triangular waveform voltage was increased to +/−10V, Then using natural cooling, panel temperature was cooled down to room temperature with voltage application. The initial molecular alignment direction of this panel was same with the buffing direction in most of the observed area, however, in a very limited area showed +/−20 deg. shifted from the buffing angle. The electro-optical measurement of this panel showed analog gray scale switching as ×20 magnification field average at polarized microscope observation.

In this example, it was found that too large voltage application at the slow cooling process degrades initial FLC molecular alignment. For instance, at the temperature the panel shows Smectic A phase, over +/−5V voltage is applied, there shows stripe alignment defect along with buffing direction. Once this type of defect happens, voltage application at Chiral smectic C phase (the ferroelectric liquid crystal phase) does not eliminate the defect. The voltage application at the slow cooling is effective, but its condition should be strictly controlled. In these examples showed that at Smectic A phase, up to 1 V/mm, from Smectic A phase to 10° C. below the Smectic A to Chiral SmC phase transition temperature, up to 1.5 V/mm, below 20° C. from the phase transition temperature, up to 5 V/mm, then lower than this temperature, up to 7.5 V/mm are preferred to obtain good result.

### Reference Example 3

(Control)

As same as Example 1, commercially available FLC mixture material (Merck: ZLI-4851-100), photo-curable the liquid crystalline material (Dai Nippon Ink Chemicals: UCL-001), and photo initiator material (Merck: Darocur 1173) based on. JP-A H11-21554, PS-V-FLCD panel was fabricated. The mixture had 93 mass % of ZLI-4851-100 FLC mixture, 6 mass % of UCL-001, and 1 mass % of Darocur 1173. For the liquid crystal molecular alignment material, RN-1199 (Nissan Chemicals Industries) was used as 1 to 1.5° of pre-tilt angle alignment material. Thickness of the alignment layer as cured layer was set at 4,500A to 5,000A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm The above mixed material was injected into the panel at the isotropic phase temperature of 100° C. After the mixed material was injected, ambient temperature was controlled to reduce 5° C. per minute till the mixed material showed ferroelectric phase (40° C.) Then by natural cooling, after the panel reached room temperature, the panel was applied +/−10 V, 500 Hz of triangular waveform, 10 minutes. After 10 minutes voltage application, 365 nm of UV light was exposed keeping application of the same voltage. The exposure power was set to 5,000 mJ/cm² This panel showed many zig-zag alignment defect which is commonly observed at the conventional SSFLCD panel. Both sides of the zig-zag defect, there observed typical domain switching which is also very popular with the conventional SSFLCD panel. This panel did not show analog gray scale switching, but showed typical binary switching. The difference in condition between Example 1 and this rapid cooling example is just cooling rate from isotropic, Smectic A phase and Chiral Smectic C-phase. The rapid cooling example showed many zig-zag defect and did not show analog gray scale.

This strongly suggests that slow cooling at Smectic A phase to Chiral Smectic C phase makes FLC molecular alignment more uniform, resulting in initial molecular alignment parallel to the buffing angle. This is exactly the mechanism the present invention claims. The uniform FLC molecular alignment has strong tendency to induce initial molecular alignment parallel to the buffing angle under the particular condition. In general, in order to obtain uniform FLC molecular alignment, and this has strong tendency to have initial molecular alignment parallel to the buffing direction, the cooling rate from Smectic A phase to Ferroelectric liquid crystal Phase (Chiral Smectic C phase) should keep at least 2° C./min, preferably, 1° C./min.

### Reference Example 4

(Control)

As same as Example 2, the liquid crystal molecular alignment material, RN-1199 (Nissan Chemicals Industries) was used as 1 to 1.5° of pre-tilt angle alignment material. Thickness of the alignment layer as cured layer was set at 6,500A to 7,000A. The surface of this cured alignment layer was buffed by Rayon cloth in the direction of 30° to center line of the substrate shown in FIG. 17. The contact length of the buffing was set to 0.1 mm at both substrates. Silicon dioxide balls with average diameter of 1.6 μm are used as space. Obtained panel gap as measured was 1.8 μm. In this panel, commercially available FLC mixture material (Merck: ZLI-4851-100) was injected at the isotropic phase temperature of 100° C. After the mixed material was injected, ambient temperature was controlled to reduce 1° C. per minute till the FLC material showed ferroelectric phase (40° C.). In this slow cooling process, from Smectic A phase to Chiral Smectic C phase (75° C. to 40° C.), +/−2 V, 500 Hz of triangular waveform voltage was applied. After panel temperature reached 40° C., applied triangular waveform voltage was increased to +/−10V. Then using natural cooling, panel temperature was cooled down to room temperature with voltage application. The initial molecular alignment direction of this panel was +/−20 deg. shifted from the buffing angle in most of the view area. The electro-optical measurement of this panel showed typical binary domain switching which is popular in the conventional SSFLCD panel as ×20 magnification field average at polarized microscope observation.

### Reference Example 5

(Control)

As same as Example 2, the liquid crystal molecular alignment material, RN-1199 (Nissan Chemicals Industries) was used as 1 to 1.5° of pre-tilt angle alignment material. Thickness of the alignment layer as cured layer was set at 150A to 200A. Thee surface of this cured alignment layer was buffed by Rayon cloth in the direction of 30° to center line of the substrate shown in FIG. 17. The contact length of the buffing was set to 0.1 mm at both substrates. Silicon dioxide balls with average diameter of 1.6 μm are used as space. Obtained panel gap as measured was 1.8 μm. In this panel, commercially available FLC mixture material (Merck: ZLI-4851-100) was injected at the isotropic phase temperature of 110° C. After the mixed material was injected, ambient temperature was controlled to reduce 1° C. per minute till the FLC material showed ferroelectric phase (40° C.). In this slow cooling process, from Smectic A phase to Chiral Smectic C phase (75° C. to 40° C.), +/−2 V, 500 Hz of triangular waveform voltage was applied. After panel temperature reached 40° C., applied triangular waveform voltage was increased to +/−10V. Then using natural cooling, panel temperature was cooled down to room temperature with voltage application. The initial molecular alignment direction of this panel was +/−20 deg. shifted from the buffing angle in most of the view area. The electro-optical measurement of this panel showed typical binary domain switching which is popular in the conventional SSFLCD panel as ×20 magnification field average at polarized microscope observation.

### Reference Example 6

(Control)

As same as Reference Example 4, the liquid crystal molecular alignment material, RN-1199 (Nissan Chemicals Industries) was used as 1 to 1.5° of pre-tilt angle alignment material. Thickness of the alignment layer as cured layer was set at 150A to 200A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm. In this panel, commercially available FLC mixture material (Merck: ZLI-4851-100) was injected at the isotropic phase temperature of 110° C. After the mixed material was injected, ambient temperature was controlled to reduce 1° C. per minute till the FLC material showed ferroelectric phase (40° C.). In this slow cooling process, from Smectic A phase to Chiral Smectic C phase (75° C. to 40° C.), +/−2 V, 500 Hz of triangular waveform voltage was applied. After panel temperature reached 40° C., applied triangular waveform voltage was increased to +/−10V. Then using natural cooling, panel temperature was cooled down to room temperature with voltage application. The initial molecular alignment direction of this panel was +/−20 deg. shifted from the buffing angle in most of the view area. The electro-optical measurement of this panel showed typical binary domain switching which is popular in the conventional SSFLCD panel as ×20 magnification field average at polarized microscope observation.

### Reference Example 7

(Control)

Using commercially available FLC mixture material (Merck: ZLI-4851-100), photo-curable the liquid crystalline material (Dai Nippon Ink Chemicals: UCL-001), and photo initiator material (Merck Darocur 1173) based on JP-A H11-21554, PS-V-FLCD panel was fabricated. The mixture had 93 mass % of ZLI-4851-100 FLC mixture, 6 mass % of UCL-001, and 1 mass % of Darocur 1173. For the liquid crystal molecular alignment material, SE-610 (Nissan Chemicals Industries) was used as 6-6.5° of pre-tilt angle alignment material. Thickness of the alignment layer as cured layer was set at 4,500A to 5,000A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm. The above mixed material was injected into the panel at the isotropic phase temperature of 110° C. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes. After 10 minutes voltage application, 365 nm of UV light was exposed keeping application of the same voltage. The exposure power was set to 5,000 mJ/cm².

The initial molecular alignment direction of this panel was +/−16 deg. shifted from the buffing angle in most of the view area. The electro-optical measurement of this panel showed typical binary domain switching which is popular in the conventional SSFLCD panel as ×20 magnification field average at polarized microscope observation.

### Reference Example 8

(Control)

Using commercially available FLC mixture material (Merck: ZLI-4851-100), photocurable the liquid crystalline material (Dai Nippon Ink Chemicals: UCL-001), and photo initiator material (Merck: Darocur 1173) based on JP-A H11-21554, PS-V-FLCD panel was fabricated. The mixture had 93 mass % of ZLI-4851-100 FLC mixture, 6 mass % of UCL-001, and 1 mass % of Darocur 1173. For the liquid crystal molecular alignment materials SE-610(Nissan Chemicals Industries) was used as 6 to 6.5° of pre-tilt angle alignment material. Thickness of the alignment layer as cured layer was set at 150A to 200A. The surface of this cured alignment layer was buffed by Rayon clothing the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm. The above mixed material was injected into the panel at the isotropic phase temperature of 100° C. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes. After 10 minutes voltage application, 365 nm of UV light was exposed keeping application of the same voltage. The exposure power was set to 5,000 mJ/cm². The initial molecular alignment direction of this panel was +/−17° shifted from the buffing direction at the most of the view area. Only some limited area showed the same direction with the buffing angle. The electro-optical measurement of this panel showed typical binary response with domain switching as the average of 20× magnification view area at the polarized microscope.

### Reference Example 9

(Control)

Using commercially available FLC mixture material (Merck: ZLI-4851-100), photo-curable the liquid crystalline material (Dai Nippon Ink Chemicals: UCL-001), and photo initiator material (Merck: Darocur 1173) based on JP-A H11-21554, PS-V-FLCD panel was fabricated. The mixture had 93 mass % of ZLI-4851-100 FLC mixture, 6 mass % UCL-00, and 1 mass % of Darocur 1173. For the liquid crystal molecular alignment material, SE-610 (Nissan Chemicals Industries) was used as 6 to 6.5° of pre-tilt angle alignment material. Thickness of the alignment layer as cured layer was set at 4,500A to 5,000A. The surface of this cured alignment layer was buffed by Rayon cloth in the direction of 30° to center line of the substrate shown in FIG. 17. The contact length of the buffing was set to 0.5 mm at both substrates. Silicon dioxide balls with average diameter of 1.6 μm are used as space. Obtained panel gap as measured was 1.8 μm. The above mixed material was injected into the panel at the isotropic phase temperature of 110° C. After the mixed material was injected, ambient temperature was controlled to reduce 2° C. per minute till the mixed material showed ferroelectric phase (40° C.). Then by natural cooling, after the panel reached room temperature, the panel was applied +/−10 V, 500 Hz of triangular waveform, 10 minutes. After 10 minutes voltage application, 365 nm of UV light was exposed keeping application of the same voltage. The exposure power was set to 5,000 mJ/cm². The initial molecular alignment direction of this panel was +/−17° shifted from the buffing direction at the most of the view area. Only some limited area showed the same direction with the buffing angle. The electro-optical measurement of this panel showed typical binary response with domain switching as the average of 20× magnification view area at the polarized microscope.

### Example 3

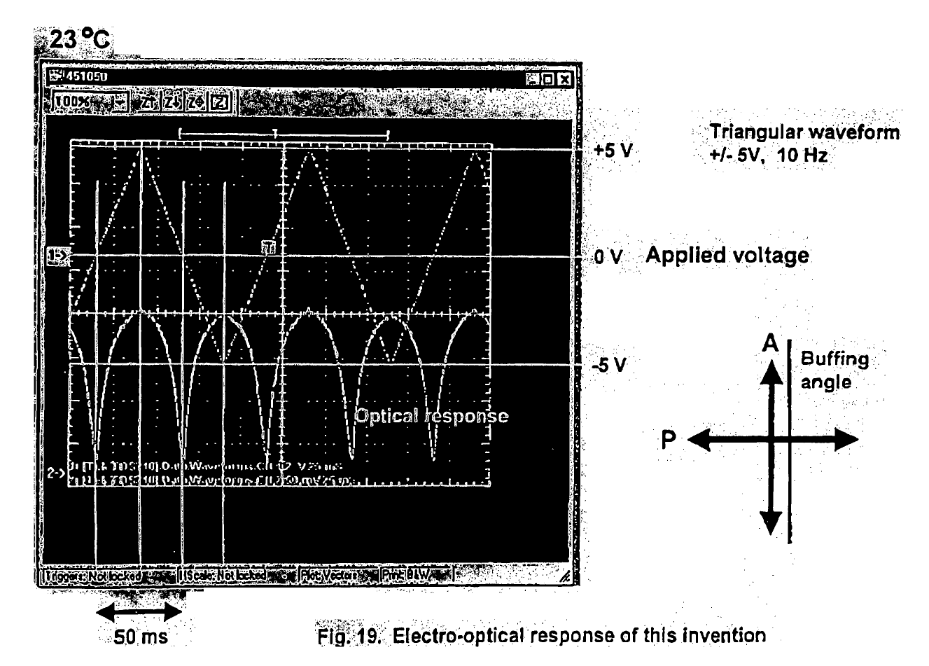

The liquid crystal molecular alignment material, RN-119 (Nissan Chemicals Industries) was used as 1 to 1.5° of pre-tilt angle alignment material. Thickness of the alignment layer as cured layer was set at 6,500A to 7,000A. The surface of this cured alignment layer was buffed by Rayon cloth in the direction of 30° to center line of the substrate shown in FIG. 17. The contact length of the buffing was set to 0.6 mm at both substrates. Silicon dioxide balls with average diameter of 1.8 μm are used as space. Obtained panel gap as measured was 2.0 μm. In this panel, Naphthalene base FLC material described in Molecular Crystals and The liquid crystals; “Naphthalene Base Ferroelectric liquid crystal and Its Electro Optical Properties”; Vol. 243, pp.77-pp.90, (1994). was injected at the isotropic phase temperature of 130° C. This FLC materials helical pitch at room temperature was 2.5 mm. After the material was injected, ambient temperature was controlled to reduce 1° C. per minute from 130° C. to 50° C. which shows ferroelectric phase. In this slow cooling process, from Smectic A phase to Chiral Smectic C phase (90° C. to 50° C.), +/−1 V, 500 Hz of triangular waveform voltage was applied. After panel temperature reached 50° C., applied triangular waveform voltage was increased to +/−7V. Then using natural cooling, panel temperature was cooled down to room temperature with voltage application. The initial molecular alignment direction of this panel was same with the buffing direction in most of the view area. Only small slight area, +/−17 deg. shifted from the buffing angle was observed. The electro-optical measurement of this panel showed analog gray scale switching as an average of the ×20 magnification field at polarized microscope observation as shown in FIG. 19. In this example, it was also found that the applied voltage waveform during slow cooling was not limited in triangular waveform, buy sine waveform, rectangular waveform were also effective to stabilize the initial molecular alignment parallel to the buffing direction.

### Reference Example 10

(Control)

The liquid crystal molecular alignment material, RN-1199 (Nissan Chemicals Industries) was used as 1 to 1.5° of pre-tilt angle alignment material. Thickness of the alignment layer as cured layer was set at 500A to 600A. The surface of this cured alignment layer was buffed by Rayon cloth in the direction of 30° to center line of the substrate shown in FIG. 17. The contact length of the buffing was set to 0.2 mm at both substrates. Silicon dioxide balls with average diameter of 1.8 μm are used as space. Obtained panel gap as measured was 2.0 μm. In this panel, Naphthalene base FLC material described in Molecular Crystals and The liquid crystals; “Naphthalene Base Ferroelectric liquid crystal and Its Electro Optical Properties”; Vol. 243, pp.77-pp.90, (1994). was injected at the isotropic phase temperature of 130° C. This FLC material's helical pitch at room temperature was 2.5 mm. After the material was injected, ambient temperature was controlled to reduce 5° C. per minute from 130° C. to 50° C. which shows ferroelectric phase. After panel temperature reached 50° C., the panel temperature was cooled down to room temperature as natural cooling. The initial molecular alignment direction of this panel was +/−18 deg. shifted from the buffing angle in most of the view area. In limited small area showed same with the buffing direction. The electro-optical measurement of this panel showed typical binary domain switching.

### Reference Example 11

(Control)

The liquid crystal molecular alignment material, RN-1199 (Nissan Chemicals Industries) was used as 1 to 1.5°of pre tilt angle alignment material. Thickness of the alignment layer as cured layer was set at 6,500A to 7,000A. The surface of this cured alignment layer was buffed by Rayon cloth in the direction of 30° to center line of the substrate shown in FIG. 17. The contact length of the buffing was set to 0.2 mm at both substrates. Silicon dioxide balls with average diameter of 1.8 μm are used as space. Obtained panel gap as measured was 2.0 μm. In this panel, Naphthalene base FLC material described in Molecular Crystals and The liquid crystals; “Naphthalene Base Ferroelectric liquid crystal and Its Electro Optical Properties”; Vol. 243, pp.77-pp.90, (1994). was injected at the isotropic phase temperature of 130° C. This FLC material's helical pitch at room temperature was 2.5 μm. After the material was injected, ambient temperature was controlled to reduce 1° C. per minute from 130° C. to 50° C. which shows ferroelectric phase. In this slow cooling process, from Smectic A phase to Chiral Smectic C phase (90° C. to 50° C.), +/−1 V, 500 Hz of triangular waveform voltage was applied. After panel temperature reached 50° C., applied triangular waveform voltage was increased to +/−7V. Then using natural cooling, panel temperature was cooled down to room temperature with voltage application. The initial molecular alignment direction of this panel was +/−17 deg. shifted from the buffing angle. Only small limited area showed the same direction with the buffing angle. The electro-optical measurement of this panel showed no analog gray scale switching as an average of the ×20 magnification field at polarized microscope observation.

### Reference Example 12

(Control)

The liquid crystal molecular alignment material, RN-1199 (Nissan Chemicals Industries) was used as 1 to 1.5° of pre-tilt angle alignment material. Thickness of the alignment layer as cured layer was set at 6,500A to 7,000A. The surface of this cured alignment layer was buffed by Rayon cloth in the direction of 30° to center line of the substrate shown in FIG. 17. The contact length of the buffing was set to 0.6 mm at both substrates. Silicon dioxide balls with average diameter of 1.8 μm are used as space. Obtained panel gap as measured was 2.0 μm. In this panel, Naphthalene base FLC material described in Molecular Crystals and The liquid crystals; “Naphthalene Base Ferroelectric liquid crystal and Its Electro Optical Properties”; Vol. 243, pp.77-pp.90, (1994). was injected at the isotropic phase temperature of 130° C. This FLC material's helical pitch at room temperature was 2.5 μm. After the material was injected, ambient temperature was controlled to reduce 3° C. per minute from 130° C. to 50° C. which shows ferroelectric phase. In this slow cooling process, from Smectic A phase to Chiral Smectic C phase (90° C. to 50° C.), no voltage was applied. After panel temperature reached 50° C., +/−7V triangular waveform voltage was applied. Then using natural cooling, panel temperature was cooled down to room temperature with voltage application. The initial molecular alignment direction of this panel was +/−16 deg. shifted from the buffing angle. The electro-optical measurement of this panel showed typical binary domain switching.

The results obtained in the above Examples are summarized in the following Table 3.

TABLE 3
Wrap-up of examples

| | | | Alignment conditions | | | | | |
|---|---|---|---|---|---|---|---|---|
| | Photo- | | | Alignment | Buffing | Temperature | Voltage application conditions | |
| | sensitive | Base FLC | Pure-tilt | layer | contact | reduction | Higher | Lower |
| Example | material | material | (deg.) | thickness (Å) | length (mm) | rate (h/min) | temperature | temperature |
| Ex. 1 | Yes | ZLI-4851-100 | 1 | 5,000 | 0.5 | 2 | No | ±10 V, 500 Hz, Triangular |
| Ref. Ex. 1 | Yes | ZLI-4851-100 | 1 | 200 | 0.5 | 2 | No | ±10 V, 500 Hz, Triangular |
| Ref. Ex. 2 | Yes | ZLI-4851-100 | 1 | 5,000 | 0.1 | 2 | No | ±10 V, 500 Hz, Triangular |
| Ex. 2 | No | ZLI-4851-100 | 1 | 7,000 | 0.5 | 1 | ±2 V, 500 Hz; Triangular | ±10 V, 500 Hz, Triangular |
| Ref. Ex. 3 | Yes | ZLI-4851-100 | 1 | 5,000 | 0.5 | 5 | No | ±10 V, 500 Hz, Triangular |
| Ref. Ex. 4 | No | ZLI-4851-100 | 1 | 7,000 | 0.1 | 1 | ±2 V, 500 Hz, Triangular | ±10 V, 500 Hz, Triangular |
| Ref. Ex. 5 | No | ZLI-4851-100 | 1 | 200 | 0.1 | 1 | ±2 V, 500 Hz, Triangular | ±10 V, 500 Hz, Triangular |
| Ref. Ex. 6 | No | ZLI-1851-100 | 1 | 200 | 0.5 | 1 | ±2 V, 500 Hz, Triangular | ±10 V, 500 Hz, Triangular |
| Ref. Ex. 7 | yes | ZLI-4851-100 | 6.5 | 5,000 | 0.5 | 2 | No | ±10 V, 500 Hz, Triangular |
| Ref. Ex. 8 | Yes | ZLI-4851-100 | 6.5 | 200 | 0.5 | 2 | No | ±10 V, 500 Hz, Triangular |
| Ref. Ex. 9 | Yes | ZLI-4851-100 | 6.5 | 5,000 | 0.1 | 2 | No | ±10 V, 500 Hz, Triangular |
| Ex. 3 | No | Naphthalene | 1 | 7,000 | 0.6 | 1 | ±1 V, 500 Hz, Triangular | ±7 V, 500 Hz, Triangular |
| Ref. Ex. 10 | No | Naphthalene | 1 | 600 | 0.2 | 1 | ±1 V, 500 Hz, Triangular | ±7 V, 500 Hz, Triangular |
| Ref. Ex. 11 | No | Naphthalene | 1 | 7,000 | 0.2 | 1 | ±1 V, 500 Hz, Triangular | ±7 V, 500 Hz, Triangular |
| Ref. Ex. 12 | No | Naphthalene | 1 | 7,000 | 0.6 | 3 | No | ±7 V, 500 Hz, Triangular |

As described hereinabove, the present invention (particularly, in the case of embodiments based on Polarization Shielded V-shaped Ferroelectric liquid crystal Displays; PS-V-FLCDs) has superiority to the conventional THE TFT-LCDs, the conventional SSFLCDs, and Polymer Stabilized V-shaped Ferroelectric liquid crystal Displays (PS-V-FLCDs) described in JP-A H11-21554 both in image quality performance and manufacturing cost for small high resolution displays and large screen direct view TVs.

For example, the present invention enables high quality image for large screen direct view TV with fast enough optical response at inter-gray scale levels with less image blur by automatic shuttering effect using most of current existing large LCD panel manufacturing equipment with proven manufacturing process. This provides cost merit in the manufacturing. The present invention also enables small screen with high resolution the LCDs using the field sequential color method, in particular for the advanced cell phone application. By using RGB LED backlight for the field sequential color system, wider color saturation makes higher image quality in its color reproduction. This is extremely important for digital still camera monitor display which needs natural color reproduction.

The present invention may also provide analytical mechanism result and concrete method to produce high performance the LCDs with reasonable manufacturing cost by detail investigation of Polymer Stabilized V-shaped Ferroelectric liquid crystal Displays and external applied voltage block effect in gigantic spontaneous polarization FLC case. Newly found unique initial molecular alignment parallel to the buffing direction in the ferroelectric liquid crystal molecules realizes polarization shielding perpendicular to the substrates, resulting in analog gray scale keeping with fast FLC optical response. The present invention provides not only above mechanism and concrete method for new high performance the LCDs, but also clarifies use of current existing large panel manufacturing line and process. This gives an economic advantage as well as technical advantage. In addition the present invention may clarify to enhance the conventional Polymer Stabilized V-shaped FLCD by showing strict condition of use of photo-curable the liquid crystalline material, and of no use of photo-curable the liquid crystal material.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

The U.S. Provisional Application Serial No. 60/440,827 filed on Jan. 16, 2003 is hereby incorporated by reference.

1. A liquid crystal device comprising: at least,
a pair of substrates; and
a liquid crystal material disposed between the pair of substrates;
wherein the molecular initial alignment in the liquid crystal material has a parallel or almost parallel direction with respect to the alignment treatment direction for the liquid crystal material; and the liquid crystal material shows almost no spontaneous polarization which is perpendicular to the pair of substrates under the absence of an externally applied voltage.

2. A liquid crystal device according to claim 1, wherein the liquid crystal material is a the ferroelectric liquid crystal material.

3. A liquid crystal device according to claim 1, wherein the liquid crystal molecular alignment treatment for the liquid crystal material is conducted by buffing.

4. A liquid crystal device according to claim 3, wherein the liquid crystal molecular alignment treatment for the liquid crystal material is conducted in conjunction with a liquid crystal molecular alignment material providing a low surface pre-tilt angle.

5. A liquid crystal device according to claim 4, wherein the low surface pre-tilt angle is 1.5° or less.

6. A liquid crystal device according to claim 2, wherein the liquid crystal material shows a bookshelf layer structure or quasi-bookshelf structure at the ferroelectric liquid crystal phase.

7. A liquid crystal device according to claim 6, wherein the helical pitch at the ferroelectric liquid crystal phase is 1.2 times or larger the panel gap distance of the liquid crystal device.

8. A liquid crystal device comprising: at least,
a pair of substrates;
a liquid crystal material disposed between the pair of substrates; and
a pair of polarizing films disposed on the outside of the pair of substrates;
wherein one of the pair of polarizing films has a molecular initial alignment which is parallel or almost parallel with the alignment treatment direction for the liquid crystal material;
the other of the pair of polarizing films has a polarizing absorption direction which is perpendicular to the alignment treatment direction for the liquid crystal material; and
the liquid crystal device shows an extinction angle under the absence of an externally applied voltage.

9. A liquid crystal device according to claim 8, wherein the liquid crystal material is a the ferroelectric liquid crystal material.

10. A liquid crystal device according to claim 8, wherein the liquid crystal molecular alignment treatment for the liquid crystal material is conducted by buffing.

11. A liquid crystal device according to claim 10, wherein the liquid crystal molecular alignment treatment for the liquid crystal material is conducted in conjunction with a liquid crystal molecular alignment material providing a low surface pre-tilt angle.

12. A liquid crystal device according to claim 11, wherein the low surface pre-tilt angle is 1.5° or less.

13. A liquid crystal device according to claim 9, wherein the liquid crystal material shows a bookshelf layer structure or quasi-bookshelf structure at the ferroelectric liquid crystal phase.

14. A liquid crystal device according to claim 13, wherein the helical pitch at the ferroelectric liquid crystal phase is 1.2 times or larger the panel gap distance of the liquid crystal device.

15. A liquid crystal device comprising: at least,
a pair of substrates; and
a liquid crystal material disposed between the pair of substrates;
wherein the current passing through the pair of substrates shows substantially no peak-shaped current, when a continuously and linearly changing voltage waveform is applied to the liquid crystal device.

16. A liquid crystal device according to claim 15, wherein the liquid crystal material is a the ferroelectric liquid crystal material.

17. A liquid crystal device according to claim 15, which shows a monotonic current, when a continuously and linearly changing voltage waveform is applied to the liquid crystal device.

18. A liquid crystal device according to claim 15, wherein the continuously and linearly changing voltage waveform is selected from the group consisting of: a triangular waveform, a sine waveform, and a rectangular waveform.

19. A liquid crystal device according to claim 15, wherein the liquid crystal molecular alignment treatment for the liquid crystal material is conducted by buffing.

20. A liquid crystal device according to claim 19, wherein the liquid crystal molecular alignment treatment for the liquid crystal material is conducted in conjunction with a liquid crystal molecular alignment material providing a low surface pre-tilt angle.

21. A liquid crystal device according to claim 20, wherein the low surface pre-tilt angle is 1.5° or less.

22. A liquid crystal device according to claim 15, wherein the liquid crystal material shows Smectic A phase to the ferroelectric liquid crystal phase sequence.

23. A liquid crystal device according to claim 22, wherein the liquid crystal device has been produced by causing a phase transition from Smectic A phase to a ferroelectric liquid crystal phase, while decreasing the device temperature at a rate of 3° C. per minute or less.

24. A liquid crystal device according to claim 23, wherein the phase transition from Smectic A phase to a ferroelectric liquid crystal phase is conducted, while applying an alternative current waveform voltage.

25. A liquid crystal device according to claim 24, wherein the alternative current waveform voltage is selected from the group consisting of: a triangular waveform, a sine waveform, and a rectangular waveform voltage.

26. A liquid crystal device according to claim 24, wherein the alternative current waveform voltage is applied so as to provide an electric field of 1 V/mm or less in the course of the phase transition from the Smectic A phase to the Ferroelectric liquid crystal phase;
the alternative current waveform voltage is applied so as to provide an electric field of 1.5 V/mm or less when the temperature is between the phase transition temperature to the Ferroelectric liquid crystal phase, and the temperature which is 10° C. lower than the phase transition temperature;
the alternative current waveform voltage is applied so as to provide an electric field of 5 V/mm or less when the temperature is between the temperature which is 10° C. lower than the phase transition temperature, and the temperature which is 20° C. lower than the phase transition temperature; and
the alternative current waveform voltage is applied so as to provide an electric field of 7.5 V/mm or less when the temperature is 20° C. or more lower than the phase transition temperature.

27. A liquid crystal device according to claim 16, wherein the liquid crystal material shows a bookshelf layer structure or quasi-bookshelf structure at the ferroelectric liquid crystal phase.

28. A liquid crystal device according to claim 27, wherein the helical pitch at the ferroelectric liquid crystal phase is 1.2 times or larger the panel gap distance of the liquid crystal device.

29. A liquid crystal device comprising: at least,
a pair of substrates; and
a liquid crystal material disposed between the pair of substrates;
wherein the liquid crystal material shows a bookshelf layer structure or quasi-bookshelf structure at the ferroelectric liquid crystal phase.

30. A liquid crystal device according to claim 1, wherein the liquid crystal material is a the ferroelectric liquid crystal material.

31. A liquid crystal device comprising: at least,
a pair of substrates; and
a liquid crystal material disposed between the pair of substrates;
wherein each of the pair of substrates has thereon a molecular alignment film having a thickness of 3,000 A or more, which has been subjected to buffing alignment treatment so as to provide a contact length of the buffing alignment treatment of 0.3 mm or more.
